(19) United States
(12) Patent Application Publication
(10) Pub. No.: US 2023/0235495 A1
(43) Pub. Date: Jul. 27, 2023

(54) USAGE DEPENDENT USER PROMPTING

(71) Applicant: KYNDRYL, INC., New York, NY (US)

(72) Inventors: Caleb MILES, Columbia, MO (US); Shikhar KWATRA, San Jose, CA (US); Hemant Kumar SIVASWAMY, Pune (IN); Sachin Suhas PATWARDHAN, Kothrud (IN)

(21) Appl. No.: 17/583,820

(22) Filed: Jan. 25, 2022

(51) Int. Cl. D06F 34/28; G06N 20/00; D06F 34/08; G06V 20/60

(52) U.S. Cl. CPC D06F 34/28; G06N 20/00; D06F 34/08; G06V 20/60; D06F 2101/02

(57) ABSTRACT

Methods, computer program products, and systems are presented. The method computer program products, and systems can include, for instance: obtaining clothing article data stream data from one or more internet of things (IoT) device disposed in a computing environment, wherein the computing environment is collocated with a residence of a user, the clothing article data stream data representing one or more clothing article of the user; examining data of the clothing article data stream data to determine at least one clothing article parameter value of the one or more clothing article; in dependence at least one clothing article parameter value of the one or more clothing article, and providing user profile data that specifies predicted behavior of the user.

### BACKGROUND

Embodiments herein relate generally to prompting targeted action, and specifically to usage dependent user prompting.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: obtaining clothing article data stream data from one or more internet of things (IoT) device disposed in a computing environment, wherein the computing environment is collocated with a residence of a user, the clothing article data stream data representing one or more clothing article of the user; examining data of the clothing article data stream data to determine at least one clothing article parameter value of the one or more clothing article; in dependence at least one clothing article parameter value of the one or more clothing article, providing user profile data that specifies predicted behavior of the user; and sending prompting data to the user, wherein the prompting data prompts the user to perform an action, and wherein the sending prompting data is performed in dependence on the user profile data.

In another aspect, a computer program product can be provided. The computer program product can include a computer readable storage medium readable by one or more processing circuit and storing instructions for execution by one or more processor for performing a method. The method can include, for example: obtaining clothing article data stream data from one or more internet of things (IoT) device disposed in a computing environment, wherein the computing environment is collocated with a residence of a user, the clothing article data stream data representing one or more clothing article of the user; examining data of the clothing article data stream data to determine at least one clothing article parameter value of the one or more clothing article; in dependence at least one clothing article parameter value of the one or more clothing article, providing user profile data that specifies predicted behavior of the user; and sending prompting data to the user, wherein the prompting data prompts the user to perform an action, and wherein the sending prompting data is performed in dependence on the user profile data.

In a further aspect, a system can be provided. The system can include, for example a memory. In addition, the system can include one or more processor in communication with the memory. Further, the system can include program instructions executable by the one or more processor via the memory to perform a method. The method can include, for example: obtaining clothing article data stream data from one or more internet of things (IoT) device disposed in a computing environment, wherein the computing environment is collocated with a residence of a user, the clothing article data stream data representing one or more clothing article of the user; examining data of the clothing article data stream data to determine at least one clothing article parameter value of the one or more clothing article; in dependence at least one clothing article parameter value of the one or more clothing article, providing user profile data that specifies predicted behavior of the user; and sending prompting data to the user, wherein the prompting data prompts the user to perform an action, and wherein the sending prompting data is performed in dependence on the user profile data.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system of a plurality of computing environments with IOT devices and a plurality of UE devices according to one embodiment;

FIG. 2 is a flowchart depicting operation of a manager system interoperating with computing environments in UE devices according to one embodiment;

FIG. 3 depicts IoT devices disposed on clothes laundering appliances according to one embodiment;

FIG. 4 depicts an IoT device disposed on a residential doorway according to one embodiment;

FIGS. 5A-5J depict predictive models trained by machine learning for return of action decisions according to one embodiment;

FIG. 6 depicts a microservices architecture which can be incorporated into a manager system according to one embodiment;

FIG. 7 depicts a method for performance of a system according to one embodiment;

FIG. 8 depicts a computing node according to one embodiment;

FIG. 9 depicts a cloud computing environment according to one embodiment; and

FIG. 10 depicts abstraction model layers according to one embodiment.

### DETAILED DESCRIPTION

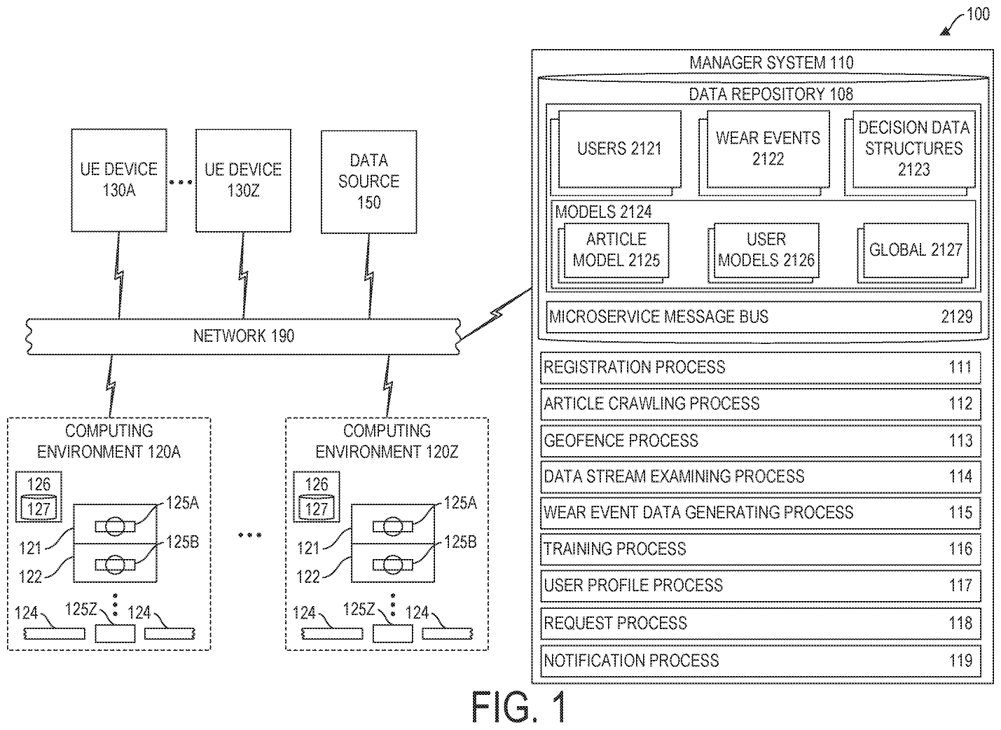

System 100 for predicting behavior of a user is shown in FIG. 1. System 100 can include manager system 110 having an associated data repository 108, computing environments 120A-120Z, and UE devices 130A-130Z. Manager system 110, computing environments 120A-120Z, and UE devices 130A-130Z can be in communication with one another via network 190. System 100 can include numerous devices, as depicted in FIG. 1, which can be computing node-based devices connected via network 190. Network 190 can be a physical network and/or a virtual network. The physical network can be, for example, a physical telecommunications network connecting numerous computing nodes or systems, such as computer servers and computer clients. The virtual network can, for example, combine numerous physical networks or parts thereof into a logical virtual network. In another example, numerous virtual networks can be defined over a single physical network.

In one embodiment, manager system 110 can be external to computing environments 120A-120Z, and one or more UE device of UE devices 130A-130Z. In one embodiment, manager system 110 can be collocated with computing environments 120A-120Z and one or more UE device of UE devices 130A-130Z.

User equipment (UE devices) 130A-130Z can be provided by, e.g., smartphones, tablets, personal computers, laptops, and the like.

Embodiments herein recognize that attributes of human behavior can be predicted in dependence on clothing articles worn by a user. Further, elements of attributes of behavior can include not only apparel selection behavior of a user, but other attributes of human behavior as well, including predicting behavior of user in terms of, e.g., pattern selections of a user and color combination selections of the user, as well as product lifetime usage behavior of a user.

Embodiments herein recognize that clothing article purchasing data has, in some scenarios, little or essentially no association to actual clothing article usage behavior of a user. Embodiments herein recognize that users often purchase voluminous amounts of clothing articles, e.g., due to impulse buying, gifting events, store lighting, etc., that are simply never worn. In some usage scenarios, a user may only wear a fraction of clothing articles that are purchased by the user. Accordingly, in one aspect, embodiments herein are set forth to capture IoT device output data that is useful for characterizing the actual clothing article usage behavior of user.

Embodiments herein recognize that clothing articles disposed in a clothes-laundering appliance, such as washing machine or clothes dryer, are likely to be articles of clothing that have actually been worn used by user, and therefore depict the actual usage behavior of a user, as opposed to clothing event purchase data which may not reflect actual usage of a user of a clothing article. In the same way, an ingress/egress doorway disposed IoT device can also accurately depict actual usage behavior of a user with reflective clothing articles. Such doorway disposed IoT devices can capture image data depicting actual clothing usage, as opposed to clothing article purchase data, which as noted, may not reflect, and in some cases does not reflect that all, the actual usage behavior of a user with respect to clothing articles. Accordingly, embodiments herein recognize that data depicting actual usage behavior of a user through the collective clothing articles can accurately reflect the actual preferences of users.

Because IoT device derived clothing article usage data can more accurately depict actual preferences of users with respect to clothing articles, such clothing article usage behavior can more accurately reflect general preferences of users, e.g., with respect to color combinations, patterns, and product usage longevity. That is, embodiments herein recognize that the user's usage behavior with respect to a clothing article lifespan can be indicative of a user's product usage lifespan, in general terms. In other words, a user who cycles through and retires clothing articles quickly can be expected to be more likely to cycle through general products more quickly. Conversely, embodiments herein recognize that a user who may wear the same article of clothing for years, or other longer lifetime spans, may be more likely to exhibit the same behavior with respect to other generical product categories, such as furniture, kitchenware, bath wear, and the like.

In one embodiment, computing environments 120A-120Z can be respectively associated to and collocated to respective residences of respective users of system 100. Each of computing environments 120A-120Z can be in a geospatial location in common with the residence of a user.

Respective computing environments of computing environments 120A-120Z can include a plurality of Internet of Things (IoT) devices 125A-125Z. IoT devices 125A-125Z of respective computing environments 120A-120Z can be, in one example, camera-based IoT devices. IoT devices 125A-125Z can be configured to sense clothing article wear usage of a user. In one example, IoT devices 125A-120Z can be disposed at a clothing laundering appliance (e.g., a washing machine or clothes dryer) at a user's residence, and IoT device 125Z can be disposed at a doorway of a user's residence.

In one example, IoT device 125A can be disposed at washing machine 121, and IoT device 125B can be disposed at clothes dryer 122. Respective computing environments 120A-120Z can include additional IoT devices for sensing clothing article wear usage by the user. IoT devices 125A-125Z disposed in respective computing environments of computing environments 120A-120Z can further include an instance of camera-based IoT device 125Z, which can be disposed at an ingress/egress doorway of the user residence (e.g., front door of a user residence defined by residence infrastructure 124).

In another aspect, computing environments of computing environments 120A-120Z can include respective manager nodes 126. Manager nodes 126 can include associated data repositories 127. In some embodiments, manager nodes 126 can be configured to perform locally any one of the processes described herein with respect to manager system 110. Respective data repositories 127 can store local instances of data described with reference to data repository 108 of manager system 110.

Manager system 110 can store various data in data repository 108. In users area 2121, data repository 108 can store data on users of a system, including registered users and guest users. Manager system 110 on registration of a user can assign a new registered user universally unique identifier UUID. In users area 2121, there can be stored various data, including registration data. Registration data can include, e.g., name data, address data, including social media account data, and any other volunteered data of the user. In users area 2121, there can also be stored in association with each user, location data of the user over time. The location data of each user can be iteratively updated over time so that location data in users area 2121 defines historical location data of each respective user of system 100. In users area 2121, there can also be stored permissions data of a user which can be included within registration data of the user. Permissions data can specify permissions defined by a user, e.g., permissions that permit manager system 110 and system 100 to use personal data volunteered by a user, including, e.g., location data.

Data repository 108 in wear events area 2122 can store data respecting wear events associated to users of system 100. In wear events area 2122, there can be stored data that specifies events wherein a user has been determined to have worn an article of clothing. Wear events as described herein can be detected with use of sensor data output by IoT devices of IoT devices 125A-120Z. Wear event data herein can include a dataset that includes wear event characterizing parameter values. Wear event characterizing parameter values can include a plurality of clothing article parameter values.

Wear event characterizing parameter values can include, e.g., a wear event identifier, a wear event timestamp, and various clothing article parameter values, e.g., a clothing article identifier such as an assigned universally unique identifier (UUID), a manufacturer model number, a clothing article owner identifier, a clothing article type (e.g., specifying a shirt, pants, dress, shorts, socks, etc.), a clothing article color, a clothing article pattern (specifying, e.g., floral, striped, checked, etc.), a clothing article brand, a clothing article style, a clothing article material, a clothing article size, a clothing article cost, a clothing article longevity, a clothing article text string (text of any labels), an associated clothing article identifier (specifying identifiers for clothing article(s) worn in combination with the clothing article associated to the wearing event). An example of a wear event dataset is set forth in reference to Table A.

TABLE A

| Wear event characterizing | Parameter |
|---|---|
| parameter | value(s) |
| Wear event identifier | XX |
| Wear event timestamp | XX |
| Clothing article identifier | XX |
| Manufacturer model number | XX |
| Clothing article owner identifier | XX |
| Clothing article type | XX |
| Clothing article color | XX |
| Clothing article pattern | XX |
| Clothing article brand | XX |
| Clothing article style | XX |
| Clothing article material | XX |
| Clothing article size | XX |
| Clothing article cost | XX |
| Clothing article longevity | XX |
| Clothing article text string | XX |
| Associated clothing article identifier | XX |

Data repository 108 in decision data structures area 2123 can store decision data structures such as tables and decision trees for use in return of action decisions. Data repository 108 in models area 2124 can store various predictive models trained by machine learning. In article model area 2125, data repository 108 can store one or more predictive model for predicting missing attributes of an article of clothing detected to have been worn by a user. In user models area 2126, data repository 108 can store various predictive models for predicting behavior of a user. In global models area 2127, data repository 108 can store a global predictive model that has been trained with training data of multiple users.

Data repository 108 can also include a microservice message bus 2129. Various processes run by manager system 110 can include and/or be defined by microservices that can iteratively interrogate microservice message bus 2129. In one aspect, a first microservice can send user profile data to microservice message bus 2129 and various notification microservices can interrogate the user profile data for triggering respective notifications associated respective ones of the notification microservices.

Manager system 110 running registration process 111 can include manager system 110 making available to a user a displayed user interface, such as a web-based user interface that permits a user to enter registration data. Manager system 110 running registration process 111 can include manager system 110 receiving registration data from a user and storing the registration data into users area 2121 of data repository 108. Registration data can include, e.g., name and contact data of a user, as well as permissions data of a user that permits manager system 110 and system 100 to use personal data of a user.

Manager system 110 running article crawling process 112 can include manager system 110 iteratively crawling one or more data source 150 for return of clothing article parameter values for storage into wear events area 2122. Data source 150 can represent multiple data sources, e.g., online retail store data sources, clothing article inventory data sources, and/or social media data sources which contain data regarding articles of clothing available for sale. Manager system 110 running article-crawling process 112 can include manager system 110 iteratively crawling one or more data source 150 for return of clothing article parameter values, including parameter value data of one or more parameter such as article type (e.g., shirts, pants), article color, article pattern, article material, article size, article brand, article cost, and other clothing article parameters as are listed in Table A. For return of such article data, manager system 110 running article-crawling process 112 can be configured to parse specification data associated to various clothing articles identified from one or more data source 150 using text-based processing, including text-parsing by natural language processing. Manager system 110 running article-crawling process 112 can include manager system 110 utilizing the iteratively obtained article attribute data for training one or more predictive models of article model area 2125. A predictive model trained with article attribute data can return a prediction as to missing article attribute parameter values associated to an article when queried with query data specifying a limited number of parameter values associated to the article. In one embodiment, a consortium of retailers can create an apparel details data repository included in wear events area 2122 and/or in article model area 2125 which has details of apparel sold in the past as well as current available stocks. Details includes types of clothes (formal, informal, clothes for function, winter/summer clothes), patterns (strips, checks, floral, plain), color, and size.

Manager system 110 can run a natural language processing (NLP) process for determining one or more NLP output parameter of a message. The NLP process can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter. By running of an NLP process, manager system 110 can perform a number of processes including one or more of (a) topic classification and output of one or more topic NLP output parameter for a received message, (b) sentiment classification and output of one or more sentiment NLP output parameter for a received message, or (c) other NLP classifications and output of one or more other NLP output parameter for the received message. In some cases, manager system 110 running an NLP process can include manager system 110 extracting a topic that maps to and is defined by a keyword topic. Topic analysis for topic classification and output of NLP output parameters can include topic segmentation to identify several topics within a message. Topic analysis can apply a variety of technologies, e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.” Manager system 110 running NLP process 113 can include manager system 110 returning NLP output parameters in addition to those specification topics and sentiments, e.g., can provide sentence segmentation tags and part of speech tags.

Manager system 110 running geofence process 113 can include manager system monitoring location data of UE devices 130A-130Z associated to respective users of system 100. In one aspect, UE devices 130A-130Z can include location sensors, e.g., global positioning system (GPS) sensors, disposed within UE devices 130A-130Z. Manager system 110 running geofences process 113 can iteratively receive location data of UE devices 130A-130Z, and can iteratively store location data of respective users into users area 2121 of data repository 108. Manager system 110 running geofences process 113 can ascertain when a user has breached a geofence, and in one embodiment, can establish geofences about various regions of interest, e.g., regions of interest associated to retail venues. In one aspect, embodiments herein recognize that a user's usage behavior in regard to clothing articles can be predictive of a user's general product preferences. Thus, embodiments herein can establish geofences to be collocated with geospatial footprints of clothing article retail venues as well as general product venues.

Manager system 110 running data stream examining process 114 can examine data streams transmitted from IoT devices of IoT devices 125A-125Z associated to respective ones of computing environments 120A-120Z. Manager system 110 running data stream examining process 114 can iteratively request that computing environments 120A-120Z, via respective IoT devices, report IoT data. In response to such data stream data requests, or by automation without specific requests, IoT devices 125A-125Z of each respective computing environment of computing environments 120A-120Z, can stream IoT data. In one embodiment, the IoT data can include camera IoT data, and can include video stream data defined by a succession of frames of video image data. Manager system 110 running data stream examining process 114 can include manager system 110 performing image recognition on received video data defined by data stream defined by data stream examining process 114. In one embodiment, manager system 110 running an image recognition process can examine spatial image data representing a feature of interest and can include manager system 110 employing pattern recognition processing using one or more of e.g., feature extraction algorithms, classification algorithms, and/or clustering algorithms. In one embodiment, manager system 110 running an image recognition process can include manager system 110 performing of digital image processing. Digital image processing can include, e.g., filtering, edge detection, shape classification, optical character recognition (OCR), and/or encoded information decoding.

In some cases, clothing article parameter values defining a candidate wear event resulting from running of a recognition stage of data stream examining process 114 can be absent of parameter values defining a full set of clothing article parameter values associated to a wear event, e.g., a candidate wear event can be missing, e.g., cost clothing article parameter value, a material clothing article parameter value, or another parameter value defining a full set of parameter values associated to a detected wear event. Manager system 110 running data stream examining process 114 can ascertain the situation where parameter values for defining a detected wear event are missing and absent, and can attempt to augment wear event data initially generated by running of recognition stage of data stream examining process 114 by query of a predictive model stored in article model area 2125. Manager system 110 running data stream data examining process 114 can query a predictive model stored in article model area 2125 to return missing parameter values regarding an article detected as part of a wear event.

Manager system 110 running wear event data generating process 115 can include manager system 110 ascertaining whether identified clothing article parameter values defining a candidate wear event are sufficient for detection of a wear event. Manager system 110 running wear event data generating process 115 can include manager system 110 considering, e.g., the count of candidate wear event characterizing parameter values captured, the classifications of such parameter values, and/or confidence level associated to candidate wear event clothing article parameter values that have been recorded.

Manager system 110 running training process 116 can include manager system 110 training various predictive models, such as a clothing article predictive model stored in article model area 2125, user-specific predictive models stored in user model area 2126, and a global model stored global area 2127.

Manager system 110 running user profile process 117 can include manager system 110 generating user profiles for users of system 100 having identifying data stored in users area 2121. Manager system 110 running user profiles process 117 can include manager system 110 querying predictive models trained by training process 116.

Manager system 110 running request process 118 can include manager system 110 processing requests for notification to be sent to users associated to UE device 130A-130Z. Manager system 110 running request process 118 can specify a request for a certain type of notification, or can receive a request for a notification from a service enterprise entity associated to manager system 110. Manager system 110 running request process 118 for requesting a notification can include manager system 110 ascertaining whether a user has breached a geofence defined by geofence process 113. Manager system 110, in one embodiment, can process a geofence breach as a request for a notification.

Manager system 110 running notification process 119 can include manager system 110 sending a notification to a user, e.g., a text-based notification for display on a display of a UE device of UE devices 130A-130Z associated to user. The text-based notification can define prompting data that prompts a user to take a specified action specified by the notification, e.g., acquire an item that is referenced in the notification. As noted, notification can be performed with microservices that iteratively interrogate messages of microservice message bus 2129 for user profile data triggering sending of a notification.

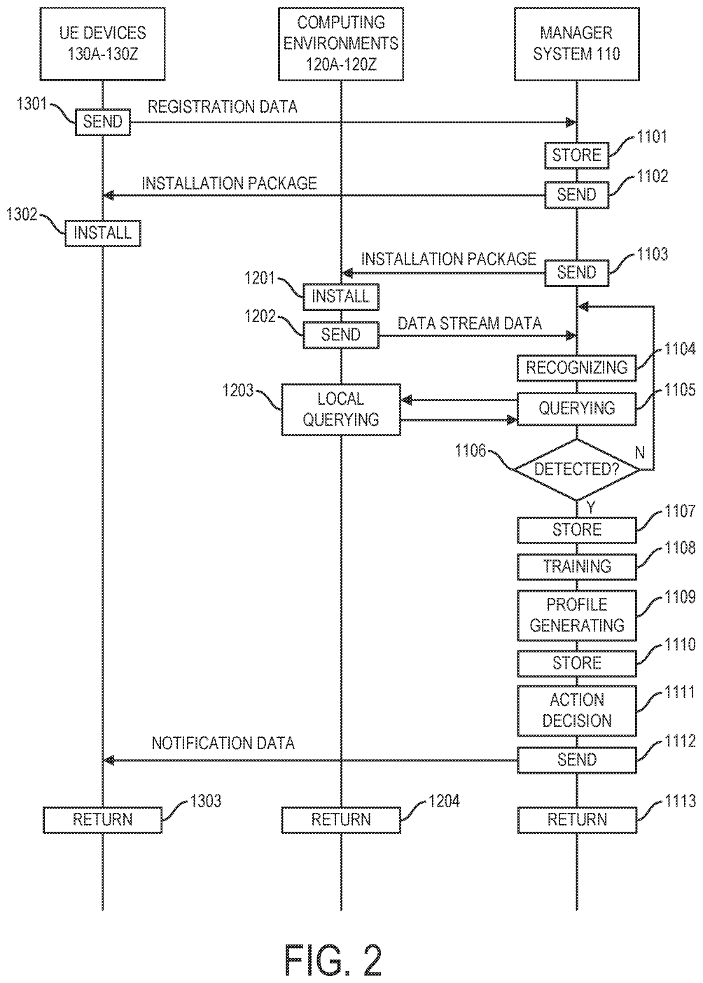

A method for performance by manager system 110 interoperating with UE devices 130A-130Z in computing environments 120A-120Z is described with reference to the flowchart of FIG. 2. At block 1301, UE devices 130A-130Z can be sending registration data. Registration data can include, e.g., name, contact information, including address information of the registering user which address information can include messaging service address information which can be defined by social media address information. Registration data can also include volunteered data volunteered by the registering user. Volunteered data can include demographic data, including, e.g., age data, educational level data, and/or domicile geospatial location data, and the like. Registration data can include, e.g., permission data of the user, which permits manager system 110 in system 100 to use personal information of the user, which personal information can include, e.g., social media information of the user as well as location data of the user. Permissions data included within registration data can also include permissions to install software onto computing nodes of a user including UE devices of a user as well as computing nodes associated to a user residence within a computing environment of computing environments 120A-120Z. The registration data can be input into user interface by the user. Permissions data of registration data sent at block 1109 included within registration data sent by UE devices at block 1301 include permissions to utilize purchase history data as may be recorded within a product purchasing application miming on a UE device of the user. Permissions data within registration data can alternatively, or in addition, include permissions to utilize banking account transaction data of a user as recorded on a user banking account or stored on a third-party banking enterprise entity system. A user interface used by a user to define registration data can be, e.g., a web-based user interface provided by webpages served by manager system 110 to UE devices 130A-130Z which render on respective displays thereof served webpages with use of web browser.

In response to receipt of registration data, manager system 110 at store block 1101 can store registration data of a user into users area 2121 of data repository 108. On receipt of registration data, manager system 110 can register the user as a registered user of manager system 110 and system 100 and can assign a new user a new registered user universal unique identifier UUID. On completion of store block 1101, manager system 110 can proceed to send block 1102. At send block 1102, manager system 110 can send an installation package to UE devices 130A-130Z. UE devices 130A-130Z at install block 1302 can install the installation package sent at block 1102. The installation package sent at block 1102 can include, e.g., libraries and executable code to facilitate participation of UE devices 130A-130Z in system 100.

In response to completion of send block 1102, manager system 110 can proceed to send block 1103. At send block 1103, manager system 110 can send installation packages to computing environments 120A-120Z for installation on IoT devices and other computing nodes of computing environments 120A-120Z. In response to receipt of the installation packages sent at block 1103, respective computing environments 120A-120Z at install block 1201 can install the received installation packages on their respective computing nodes. The installation packages sent to block 1103 can include, e.g., libraries and executable code to facilitate participation of computing environments 120A-120Z in system 100 and manager system 110.

At install block 1201, computing environments 120A-120Z can install the received installation packages sent to block 1103. The installation packages installed at block 1201 can facilitate participation of IoT devices 125A-125Z, as well as manager node 126 of respective computing environments of computing environments 120A-120Z in system 100.

In some embodiments, with the sending of installation packages at block 1103, manager system 110 can dispatch a fleet of self-driving vehicles to computing environments 120A-120Z. The self-driving vehicles can be carrying hardware including IoT devices 125A-125Z for installation in respective computing environments 120A-120Z. With the self-driving vehicles, there can further be dispatched robots for installation of hardware for configuring computing environments 120A-120Z for participation in system 100. The hardware can include, e.g., camera-based IoT devices defining IoT devices 125A-125Z of respective computing environments 120A-120Z. The described robots can be configured to install the respective camera-based IoT devices 125A-125Z at specified locations, such as at clothes-laundering appliances or and/or doorways within computing environments 120A-120Z which can be collocated with respective users' residences. In one use case, self-driving vehicles and robots are envisioned for installation hardware configuration of IoT devices 125A-125Z, within the user's residence. In another use case, IoT devices 125A-125Z can be manually installed and configured within a residence of a user.

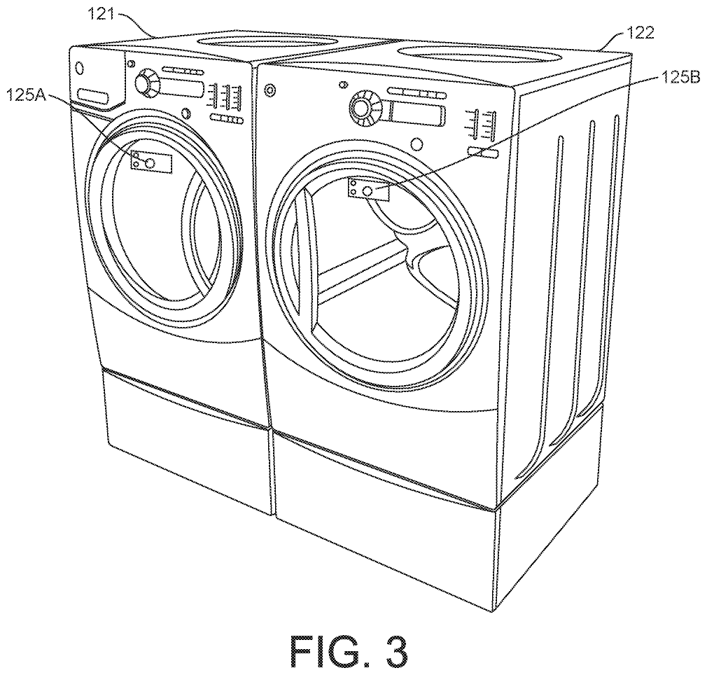

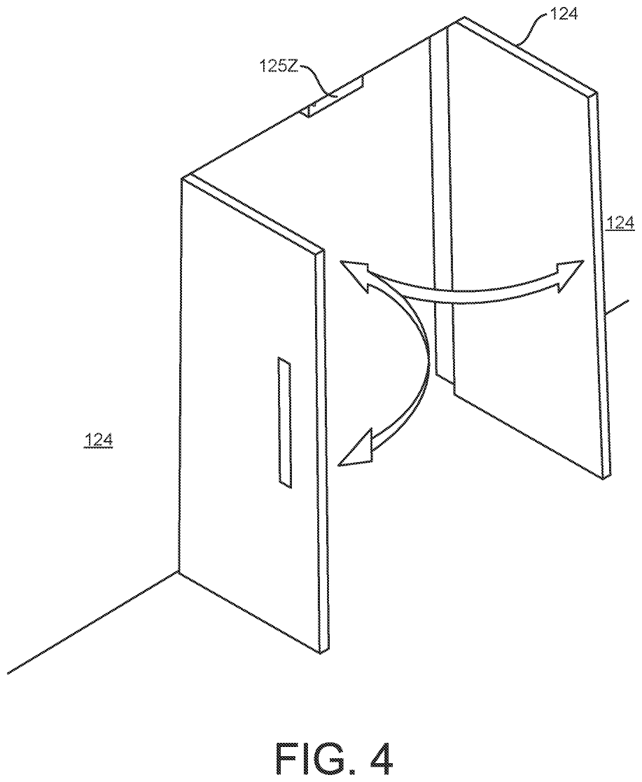

Referring to FIG. 1, camera-based IoT device 125A can be disposed at washing machine 121. Camera-based IoT device 125B can be disposed at clothes dryer 122, and camera-based IoT device 125Z can be disposed at an ingress/egress doorway of a user's residence. Further aspects of IoT devices 125A-125Z are described with reference to FIG. 3 and FIG. 4.

FIG. 3 is a perspective view illustrating first and second clothes-laundering appliances, which may be disposed in a residence of respective user. The clothes-laundering appliance can include, e.g., washing machine 121 and clothes dryer 122. IoT device 125A can be a camera-based IoT device that provides 360° viewing angles. Camera-based IoT device 125A, in one embodiment, can be configured to provide video data stream prior to loading of clothes into washing machine 121, during loading of clothes into washing machine 121, and during washing when the depicted door of washing machine 121 is closed. Camera-based IoT device 125A can be disposed, in one embodiment, on the depicted door of washing machine 121. Similarly, camera-based IoT device 125B can also provide a 360° viewing angle. where IoT device 125B can be disposed on clothes dryer 122. Camera-based IoT device 125B can be disposed on the depicted door of clothes dryer 122. Camera-based IoT device 125B can be disposed to provide video streaming prior to loading of clothes within clothes dryer 122, during loading of clothes within clothes dryer 122, and after loading of clothes within clothes dryer 122, after the depicted door is closed. Camera-based IoT devices 125A and 125B can be configured to iteratively stream video streams to manager system 110 for processing by manager system 110.

FIG. 4 depicts IoT device 125Z disposed at a doorway of a user residence defined by residence infrastructure 124. The defined doorway can be an ingress/egress doorway of a residence of a user, e.g., the front door. As shown in FIG. 4, IoT device 125Z can be a camera-based IoT device disposed at the top of the defined doorway. Camera-based IoT device 125Z can be configured to provide 360° camera viewing so that a field-of-view of camera-based IoT device 125Z encompasses a user while the user exits a residence, i.e., encompasses the user while the user is positioned at a position about the residence ingress/egress doorway defined by residence infrastructure 124. There is set forth herein a method comprising obtaining clothing article data stream data from one or more internet of things (IoT) device disposed in a computing environment, wherein the computing environment is collocated with a residence of a user, the clothing article data stream data representing one or more clothing article of the user; examining data of the clothing article data stream data to determine at least one clothing article parameter value of the one or more clothing article; in dependence at least one clothing article parameter value of the one or more clothing article, providing user profile data that specifies predicted behavior of the user; and sending prompting data to the user, wherein the prompting data prompts the user to perform an action, and wherein the sending prompting data is performed in dependence on the user profile data. In one embodiment, IoT devices 125A-125Z can be iteratively capturing frames of image data, wherein the iteratively captured frames of image data represent, e.g., clothing articles disposed within or about a clothes laundering appliance, and/or clothing articles being worn by a user positioned about a residential ingress/egress doorway. Accordingly, there is further set forth herein, e.g., a method wherein the data stream data representing one or more clothing article of the user includes a representation of the one or more clothing article captured while the one or more clothing article is disposed in a clothes-laundering appliance. Accordingly, there is further set forth herein, e.g., a method wherein the data stream data representing one or more clothing article of the user includes a representation of the one or more clothing article captured with the one or more clothing article being worn by the user while the user is exiting the residence.

On completion of install block 1201, computing environments 120A-120Z can be configured to stream data stream data. At send block 1202, computing environments 120A-120Z, by the respective IoT devices 125A-125Z, can be streaming data stream data for receipt by manager system 110.

On receipt of the data stream data from computing environments 120A-120Z by the respective IoT devices 125A-125Z, manager system 110 can perform recognizing at block 1104. At recognizing block 1104, manager system 110 can be performing image recognition. Image recognition at block 1104 can include, e.g., pattern recognition and optical character recognition. In one embodiment, manager system 110 running an image recognition process can examine spatial image data representing a feature of interest and can include manager system 110 employing pattern recognition processing using one or more of, e.g., feature extraction algorithms, classification algorithms, and/or clustering algorithms. In one embodiment, manager system 110 running an image recognition process can include manager system 110 performing of digital image processing. Digital image processing can include, e.g., filtering, edge detection, shape classification, optical character recognition (OCR), and/or encoded information decoding. IoT devices 125A-125Z can be configured to be enabled for collection of image data in the visible light spectrum. In some embodiments, IoT devices 125A-125Z, in addition or alternatively, can be configured to be spectroscopy-enabled for collection of image data in non-visible wavelength bands. Embodiments herein recognize that larger detection bands can facilitate enhanced detections on material compositions in some embodiments.

In one aspect, recognition at block 1104 can include recognizing, e.g., shapes, colors, and patterns. Recognizing at block 1104 can include optical character recognition to read text-based data, e.g., on labels of clothing articles. The text-based data can include, e.g., text-based data specifying a product identifier of a clothing article, and in some cases, a material composition of a clothing article. In some use cases, recognizing at block 1104 can include recognizing a complete set of parameter values characterizing a clothing article as described in reference to Table A. In another use case, recognizing at block 1104 can include recognizing and deriving a partial set of the complete set of clothing article characterizing parameter values, as depicted in Table A. For example, in some use cases, clothing articles, while being loaded prior to, during, and after loading of a clothing article into a clothes-laundering appliance, can be insufficient for full characterization and derivation of all parameter values. For example, a clothing article might be folded in a manner to obscure recognition of a shape of an article. In some cases, a material composition of an article might not be resolvable by processing of data output by an IoT device. Notwithstanding, manager system 110 can be configured to comprehensively characterize clothing articles irrespective of a complete set of information being derivable by use of recognizing at block 1104.

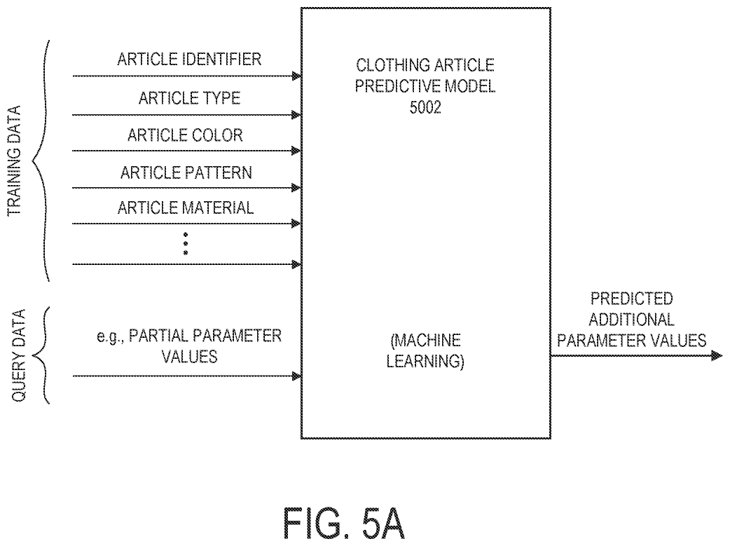

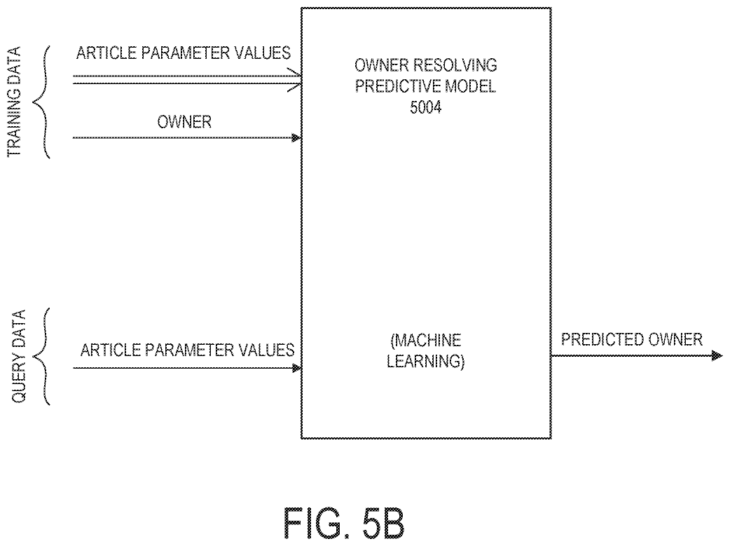

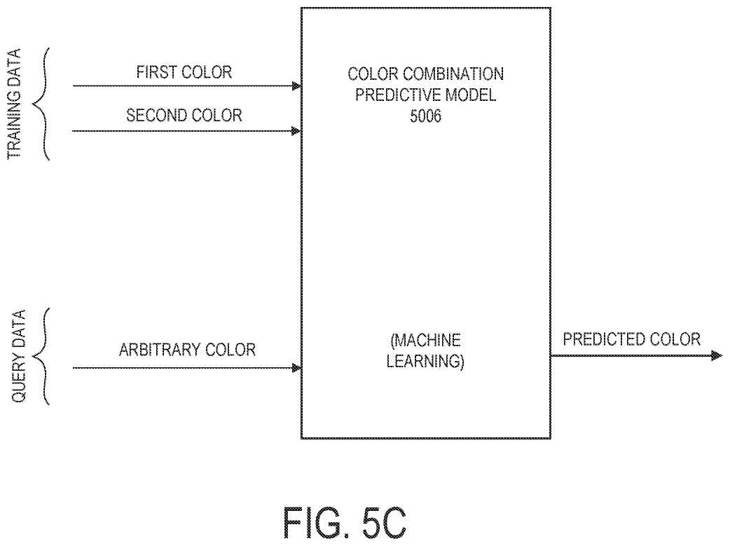

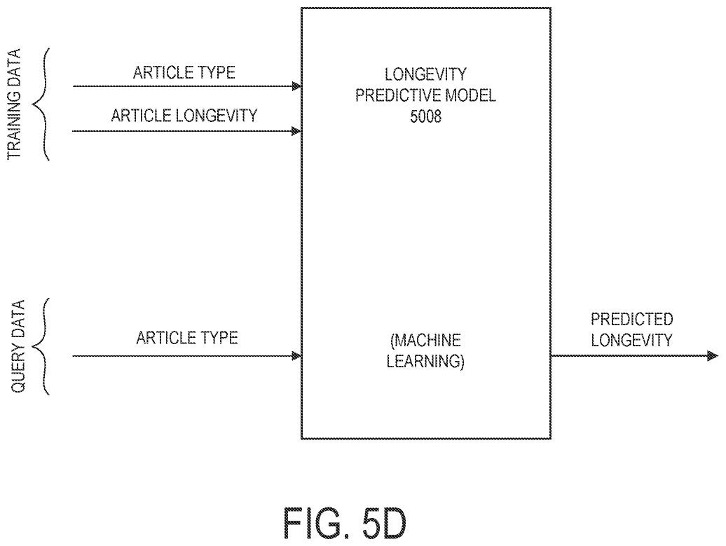

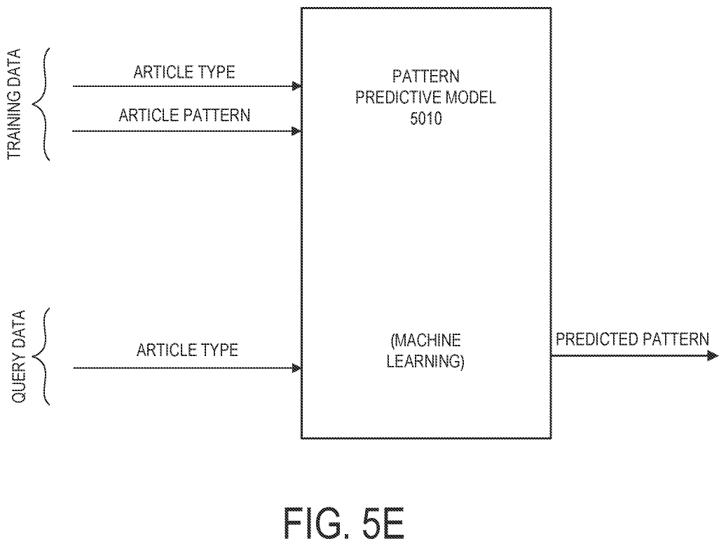

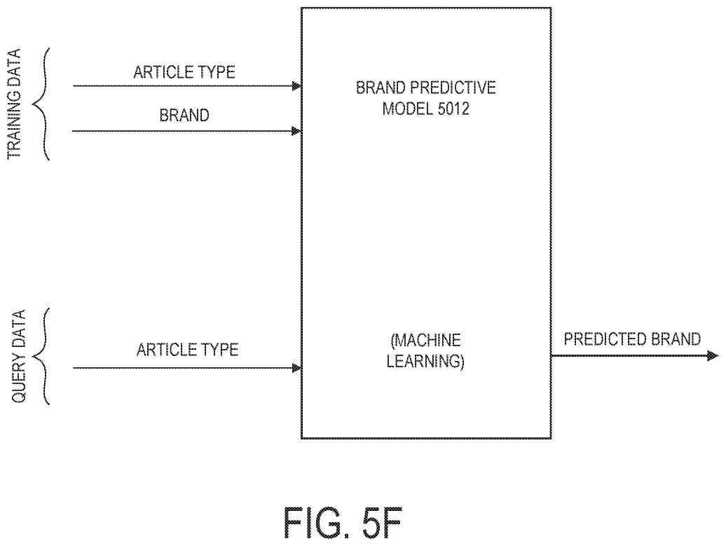

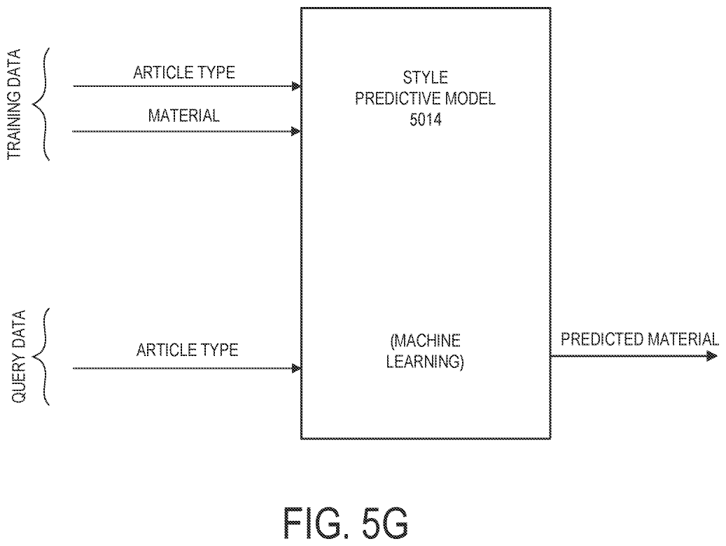

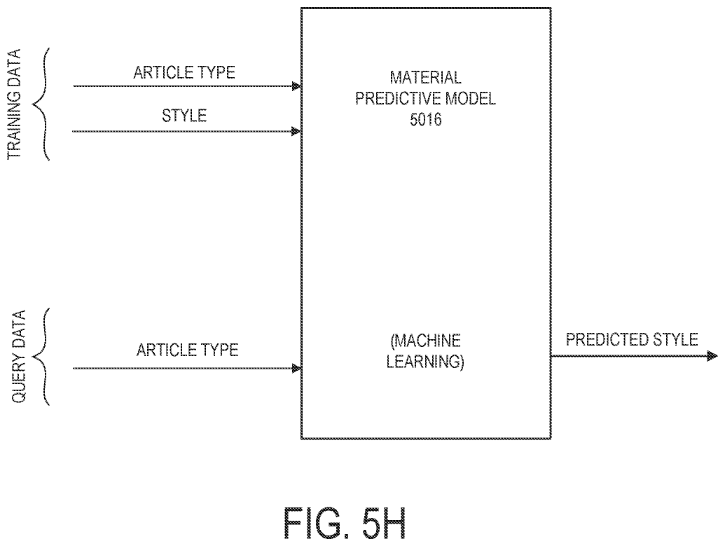

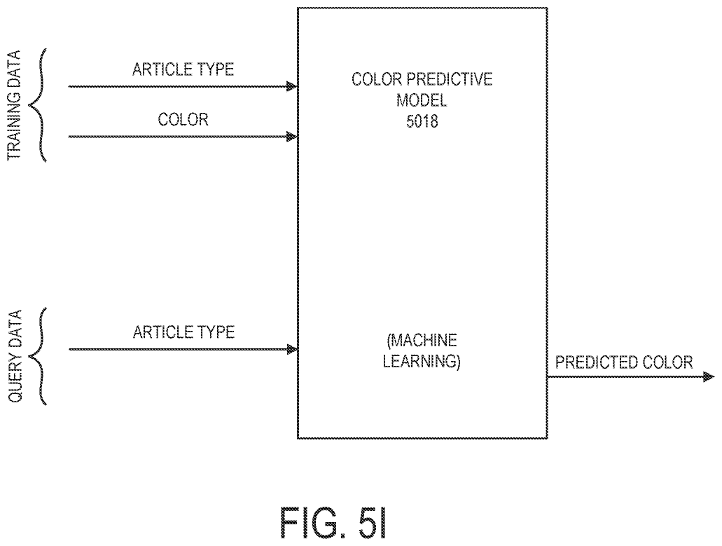

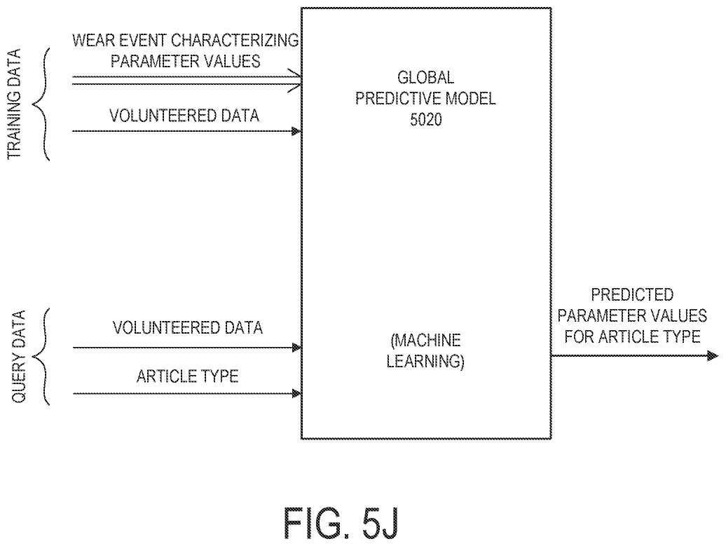

On the determination of manager system 110 that performance of recognizing at block 1104 has returned incomplete data provided by clothing article characterizing parameter values, manager system 110 can perform querying at block 1105. Manager system 110 performing querying at block 1105 can include manager system 110 querying clothes article predictive model 5002, as depicted in FIG. 5A. Clothing article predictive model 5002 can be stored in article models area 2125 of models area 2124 of data repository 108. Manager system 110 running training process 116 can iteratively train clothing article predictive model 5002 with use of article crawling process 112. Manager system 110 running article crawling process 112 can iteratively crawl one or more data source 150 for return of clothing article data for training clothing article predictive model 5002. In article models area 2125, there can be an associated article details data repository for storing clothing article parameter values associated to each respective article identified during article crawling process 112 iteratively performed by manager system 110. Clothing article predictive model 5002 can be iteratively trained with iterations of training data. Iterations of training data for training clothing article predictive model 5002 can include all clothing article parameter values returned on the identification of the specific clothing article identified by performance of article crawling process 112.

Depicted in FIG. 5A, the set of clothing article parameter values can include, e.g., an article identifier, an article-type, an article color, an article pattern, an article material, in a variety of different parameter values, e.g., size, style, brand, and the like as summarized in Table A. Clothing article predictive model 5002, once trained, can be configured to respond to query data. Training clothing article predictive model 5002, as described, enables clothing article predictive model 5002 to learn relationships between parameter values characterizing a specific article of clothing. Clothing article predictive model 5002, once trained, can be configured to respond to query data. Query data can include, e.g., partial parameter values characterizing a clothing article.

In one use case, the partial parameter values for querying clothing article predictive model 5002 can include partial parameter values returned by performance of a recognition stage of data stream examining process 114 which can be performed at recognizing block 1104. For example, on return of partial parameter values at block 1104, e.g., just pattern and identifier, or just pattern, or just color, or just material in pattern, or just material in color, or just identifier and type, or just a portion of text read from a label via OCR, manager system 110 can attempt to determine additional parameter values characterizing an identified clothing article using clothing article predictive model 5002 trained by machine learning.

On querying clothing article predictive model 5002 using partial parameter values returned by performance of recognizing block 1104, clothing article predictive model 5002 can output predicted additional parameter values to characterize the identified clothing article and to further characterize a candidate wear event. In one embodiment, returned article characterizing parameter values at recognizing block 1104, and/or returned by performance of querying block 1105, can be returned with associated confidence levels. Manager system 110 can use the returned confidence level associated to a parameter value returned by recognizing block 1104 to filter out which parameter values are used for querying. The confidence levels associated to clothing article characterizing parameter values returned by querying block 1105 can be used to determine whether a wear event has been detected. The confidence level associated to recognizing block 1104 can also be used to determine whether a clothing article parameter value is to be used in a wear event dataset associated to a detected wear event.

On completion of recognizing block 1104 and querying block 1105, manager system 110 can proceed to block 1106. At block 1106, manager system 110 can ascertain whether sufficient information has been returned for identifying and recording of a wear event. On determination that there is insufficient information for return of a wear event, manager system 110 can return to a processing stage preceding receipt of data stream data to iteratively receive a next data stream data and can iteratively perform the loop of blocks 1104 through 1106 until a wear event has been identified at block 1106.

In one embodiment, manager system 110 can determine that sufficient information has been returned for recording of a wear event in dependence on the number and classification of clothing article parameter values that have been returned by performance of recognizing block 1104, and querying block 1105, and/or confidence levels associated to such returned parameter values.

Referring again to Table A, there can be N target wear event characterizing parameter values associated to a wear event defined by a full set of wear event characterizing parameter values. In one embodiment, manager system 110 can record a wear event in the case that a threshold satisfying percentage of target wear event characterizing parameter values have been identified with a threshold satisfying level of confidence. Data stream data processing, by recognizing block 1104 and querying block 1105, can be performed with respect to data stream data output by IoT devices 125A-125Z disposed on clothes-laundering appliances, e.g., one or more of washing machine 121 and/or clothes dryer 122, as depicted is in FIG. 3, as well as alternatively with use of IoT device 125Z depicted in FIG. 4, which is an IoT device disposed in a doorway of a residence.

Referring to Table A, one clothing article parameter value is the owner parameter value, which specifies the owner of a clothing article. In one use case, the clothes-laundering appliances of FIG. 3 may service, e.g., a household with multiple candidate owners for each respective clothing article. In such use cases, manager system 110 can use owner resolving predictive model 5004 to resolve ownership of clothing articles that may be disposed in a clothes-laundering appliance, as shown in FIG. 3. Owner resolving predictive model 5004 can be trained with training data, and once trained, can be configured to respond to query data. Training data for training owner resolving predictive model 5004 can include iterations of training data. The iterations of training data can include a set of article parameter values associated to a known owner of the clothing article, wherein the article parameter values are associated to a specific clothing article. In the described scenario, owner resolving predictive model 5004 can be trained using supervised machine learning training, where specific clothing article parameter values are associated to a known owner. Over iterations of applied training data, owner resolving predictive model 5004 learns of clothing article parameter values, e.g., size, type, pattern style, brand, that are associated to a specific owner. Owner resolving predictive model 5004, once trained, is able to respond to query data. Owner resolving predictive model 5004, once trained, is able to predict the owner of a given clothing article based on article parameter values characterizing the given clothing article. Query data for querying owner resolving predictive model 5004 can include a set of clothing article parameter values, e.g., as determined at recognizing block 1104. In response to the applied query data, owner resolving predictive model 5004 can return a prediction as to the owner of the clothing article.

Thus, when a clothing article is recognized by recognizing block 1104, manager system 110 can use, e.g., partial returned parameter values returned at recognizing block 1104 as applied query data, (e.g., size, type, pattern style, brand) for querying owner resolving predictive model 5004 to return a prediction as to the predicted owner of the clothing article. Manager system 110 can apply that returned owner parameter value as the resolved owner parameter value in a dataset defining a candidate wear event for evaluation.

Embodiments herein recognize that once manager system 110 recognizes a certain article of clothing within a residence a first time, manager system 110 can more readily and quickly, and with a greater level of confidence, recognize the same article in subsequent recognition iterations.

In some use cases, local manager nodes 126 associated to respective computing environments 120A-120Z can store in their respective data repositories 127 local versions of clothing article predictive model 5002, described with reference to FIG. 5A. Training data for training the local instances of clothing article predictive model 5002 can be limited to training data associated to previously recognized articles of clothing recognized within a specific residence associated to a specific computing environment 120A. On recognition of a limited set of parameter values, during an early stage of recognition process at recognizing block 1104, querying block 1105 can be triggered to result in messaging of computing environment of computing environments 120A-120Z to perform at local querying block 1203 a local querying of the local instance of clothing article predictive model 5002 for return of predicted remaining parameter values indicated by local querying block 1203. Return data including returned clothing article parameter values returned by the local querying can be sent back to manager system 110 for inclusion in candidate wear event data being iteratively evaluated at block 1106.

One parameter value of a clothing article characterizing parameter value data set is clothing article longevity parameter value. On recognition of the certain clothing article within a residence a first time, manager system 110 can record within wear events area 2122 a baseline initial wear event timestamp for the clothing article and can record the timestamp for the initial wear event as a time of an initial wear event, e.g., indicative of the first time that a user has worn the certain article of clothing. At subsequently detected wear events, manager system 110 can subtract the time of origin from the current time specified by the timestamp of the current wear event to return a clothing article longevity parameter value that specifies the current length of time that a certain clothing article has been used since the time of the first usage. In addition to or in place of the data value specifying the current length of time that that a certain clothing article has been used since the time of the first usage, manager system 110 can include in the longevity parameter value a data value that specifies a number of wearing events since the initial wear event. For providing such a data value indicating the number of wear events, manager system 110 can count a number of detected wear events in which the current clothing article has been identified, and can include that data value in the longevity parameter value of a current wear event. Manager system 110 can apply the clothing article longevity parameter value for use in the presentation of notifications to users in respect to general article acquisition opportunities informed by history data of data repository 108 indicating the user's product lifespan span behavior patterns.

Another clothing article characterizing parameter value specified in Table A is the clothing article parameter value referred to as the associated article parameter value. The associated article parameter value specifies an identifier for one or more clothing articles worn in combination with the current clothing article specified in a wear event data set. Manager system 110 can return associated article parameter values, e.g., in the case that data stream data from a doorway disposed IoT device 125Z is processed to ascertain that multiple articles of clothing are being worn together in combination, or in the case that multiple clothing articles of a common owner are identified within a clothes-laundering appliance at a common time.

Regarding the clothes-laundering appliance example, the returned level of confidence associated with such identifications can be smaller in the case that there are voluminous amounts of clothing articles to a common owner within a clothes-laundering appliance at a common time, but the confidence can increase if there are limited number of clothing articles associated to a common user within a clothes-laundering appliance at a current time, e.g., if only a shirt and a pair of pants associated to a common owner are found within a clothes-laundering appliance at a current time, it can be assumed with a higher degree of confidence that the owner wore the shirt and pants combination at a common time in a single wear. In one embodiment, where identification of a combination is made using a data stream data output from doorway disposed IoT device 125Z, manager system 110 can assign a higher level of confidence to a detected article associated to a current identified clothing article, than in the case that an associated article is identified using data stream data from a clothes-laundering appliance disposed IoT device 125A or 125B. Referring to IoT device 125Z, as shown in FIG. 4, manager system 110 can return a confidence level of near certainty when examination of video data indicates that certain clothing articles, e.g., a shirt and pants combination are worn together, when there is a video representation of the articles of clothing actually being worn together.

On detection of a wear event at block 1106, manager system 110 can proceed to block 1107. At block 1107, manager system 110 can store in wear events area 2122 of data repository 108 the clothing article parameter values and additional parameter values defining the detected wear event. Regarding store block 1107, manager system 110 can include features to avoid double counting of a single wear event as multiple wear events. For example, manager system 110 can examine timestamp data of a detected wear event to ascertain that the detected wear event matches a prior detected wear event of a common laundering cycle (e.g., a drying stage following a washing stage can be regarded to be part of a common laundering cycle). In some use cases, manager system 110 can update a previously recorded wear event with updated parameter values on the detection of a wear event. Manager system 110 can ascertain that a newly detected wear event was previously detected in a common laundering cycle, but that with the new detection, addition parameter values are identified that characterize the wear event. In such a situation, manager system 110 can the described new parameter values to the previously recorded wear event data record. In some use cases, first parameter values characterizing a certain wear event can be captured by processing of IoT data stream data from a doorway disposed IoT device 125Z (where present), and the data record of the certain wear event can be supplemented with additional parameter values extracted as a result of processing IoT data stream data from the clothes-laundering IoT device 125A or 125B (where present). On completion of block 1107, manager system 110 can proceed to training block 1108.

At block 1108, manager system 110 can perform machine learning training of various machine learning predictive models using the iteration of training data defined by the detected wear event recorded and stored at block 1107. Manager system 110 can iteratively train a variety of predictive models at training block 1108.

At training block 1108, manager system 110 can perform an iteration of training of a variety of predictive models associated to a user of the wear event detected at block 1106. Manager system 110 can be iteratively and simultaneously performing training at block 1108 for a plurality of users of system 100. Predictive models 5006, 5008, 5010, 5012, 5014, 5016, and 5018 described with reference to FIGS. 5C-5H can be predictive models associated to one certain user. There can be an instance of each predictive model described with reference to FIGS. 5C-5H for each user of system 100. Predictive models 5006, 5008, 5010, 5012, 5014, 5016, and 5018 can be trained with a subset of parameter values associated to a detected wear event, or in the case of predictive model 5006, related wear events.

In FIG. 5C, there is described color combination predictive model 5006. Color combination predictive model 5006 can be trained with training data to predict a user's preferences with respect to color combinations. Training data for training color combination predictive model 5006 can include dataset data associated to different wear events of the user, wherein the wear events are events in which an associated article associated to the current clothing article has been detected to have been worn in combination with a current article, i.e., the associated article parameter value described with reference to Table A. The iterations of training data for training color combination predictive model 5006 can include: (a) the detected color of the clothing article associated to a wear event; and (b) the color of the associated clothing article identified as being associated to the clothing article featured in a detected wear event. Thus, an iteration of training data can include a first color of clothing associated to a first clothing article, and a second color associated to a second clothing article identified as being worn by user, in combination simultaneously and together.

When color combination predictive model 5006 has been trained with sufficient training data, color combination predictive model 5006 can be configured to return predictions in response to applied query data. Query data for querying color combination predictive model 5006 can include a specifier for an arbitrary color. In response to applied query data, color combination predictive model 5006 can return a prediction as to the predicted color preferred in combination with the designated arbitrary color.

FIG. 5D illustrates longevity predictive model 5008. Longevity predictive model 5008 can be trained with iterations of training data to predict a longevity of the clothing article associated to a user, i.e., how long the user will use a certain clothing article of a certain type (and/or how many wears). Training data for training longevity predictive model 5008 can include a subset of parameter values associated to different wear events of the user. Training data for training longevity predictive model can include, for an iteration of training data, (a) an article type in combination with (b) an article longevity parameter value identified for the article of a wear event. Trained as described, longevity predictive model 5008 can learn of the relationship between article type and article longevity for that specific article type, e.g., shirt, pants, dress, socks, and the like. An iteration of training data for training longevity predictive model 5008 can include an article type parameter value and an article longevity parameter value taken from a common wear event, as recorded in wear events area 2122. The longevity parameter value can specify, e.g., one or more of a length of time from an initial detected wear or a count of wear events. Longevity predictive model 5008, once trained, can be configured to respond to query data. Query data for querying longevity predictive model 5008 can include a specifier for article type. In response to the applied query data for querying longevity predictive model, longevity predictive model 5008 can return a prediction as to the predicted longevity (e.g., in terms of length of time since initial wear, and/or number of wear events) associated to the article type.

FIG. 5E illustrates pattern predictive model 5010. Pattern predictive model 5010 can be trained with training data in order to predict a preferred pattern preferred by a user, e.g., floral pattern, checked pattern, stripe pattern, or the like. Pattern predictive model 5010, like longevity predictive model 5008, can be trained with iterations of training data, wherein each training iteration of training data comprises first and second parameter values taken from a common wear event that is recorded in wear events area 2122. Pattern predictive model 5010 can be trained with multiple iterations of training data. A given iteration of training data for training pattern predictive model 5010 can include (a) article type in combination with (b) article pattern associated to the article type, for a certain wear event detected by manager system 110. Pattern predictive model 5010, once trained, is able to respond to query data. Query data for querying pattern predictive model 5010 can include query data that specifies a certain article type, e.g., shirts, pants, dress, socks, and the like. In response to the applied query data, pattern predictive model 5010 can return a prediction as to a pattern that is preferred by the user associated to the designated article type.

FIG. 5F illustrates brand predictive model 5012. Like longevity predictive model 5008 and pattern predictive model 5010, brand predictive model 5012 can be trained with iterations of training data, wherein each training data is associated to a certain wear event detected by manager system 110. An iteration of training data for training predictive model can include (a) article type for a certain wear event and, in combination with (b) a brand associated to the article type for the certain wear event. Brand predictive model 5012 can predict brand preference of the user. Brand predictive model 5012 can be trained with iterations of training data. Brand predictive model 5012, once trained, can be configured to respond to query data. Query data for querying brand predictive model 5012 can include a specifier for article type. In response to being queried with a query data specifying article type, brand predictive model 5012 can return a prediction as to a brand preferred by the user for the specified article type, e.g., shirt, pants, dress, socks, and the like.

FIG. 5G illustrates style predictive model 5014. Style predictive model 5014 can be trained with training data to predict a style preferred by a user for a particular article type. Styles can include various classifications, such as classical style, modern style, or contemporary style. Like longevity predictive model 5008, pattern predictive model 5010, and brand predictive model 5012, style predictive model 5014 can be trained with iterations of training data, wherein each iteration corresponds to one wear event detected by manager system 110. An iteration of training data for training style predictive model 5014 can include an article type associated to a certain wear event and an article type style parameter value associated to the certain wear event. Style predictive model 5014, once trained with sufficient iterations of training data, can be configured to return predictions in response to applied query data. Query data for querying style predictive model 5014 can include a specifier for article type. In response to the applied query data, style predictive model 5014 can return a prediction as to the style preferred by the user for the particular article type.

FIG. 5H illustrates material predictive model 5016. Material predictive model 5016 can be trained with training data to predict a material preferred by a user for a particular article type. Material can include various classifications, such as cotton, wool, polyester, rayon, end the like. Like longevity predictive model 5008, pattern predictive model 5010, brand predictive model 5012, and style predictive model 5014 material predictive model 5016 can be trained with iterations of training data, wherein each iteration corresponds to one wear event detected by manager system 110. An iteration of training data for training material predictive model 5016 can include an article type associated to a certain wear event and an article type material parameter value associated to the certain wear event. Material predictive model 5016 once trained with sufficient iterations of training data, can be configured to return predictions in response to applied query data. Query data for querying material predictive model 5016 can include a specifier for article type. In response to the applied query data, material predictive model 5016 can return a prediction as to material preferred by the user for the particular article type.

FIG. 5I illustrates color predictive model 5018. Color predictive model 5018 can be trained with training data to predict a color preferred by a user for a particular article type. Color can include various classifications, such as red, green, blue, and the like. Like longevity predictive model 5008, pattern predictive model 5010, brand predictive model 5012, style predictive model 5014, and material predictive model 5016, color predictive model 5018 can be trained with iterations of training data, wherein each iteration corresponds to one wear event detected by manager system 110. An iteration of training data for training color predictive model 5018 can include an article type associated to a certain wear event and an article color parameter value associated to the certain wear event. Color predictive model 5018, once trained with sufficient iterations of training data, can be configured to return predictions in response to applied query data. Query data for querying color predictive model 5018 can include a specifier for article type. In response to the applied query data, color predictive model 5018 can return a prediction as to a color preferred by the user for the particular article type.

Regarding outputs of predictive models 5006, 5008, 5010, 5012, and 5014, 5016, 5018, the described predictive models can be configured to provide multiple outputs in an ordered list, e.g., for predictive specifying or ranking of outputs with confidence levels associated to each alternative output. That is, predictive model 5006 can output multiple predicted colors predicted to be associated with an arbitrary color specified by query data, wherein confidence levels are specified in associated to each respective output. Similarly, pattern predictive model 5010 can specify alternative patterns, with confidence levels associated with each alternative pattern. Brand predictive model 5012 can output alternative brands with confidence levels associated to each output brand, and style predictive model 5014 can output a plurality of alternative styles in ordered ranking with confidence levels associated to the predicted styles. Material predictive model 5016 can output alternative materials with confidence levels associated to each output material. Color predictive model 5018 can output alternative colors with confidence levels associated to each output color.

Training at block 1108 can also include training of global predictive model 5020 as shown in FIG. 5J. While predictive models 5006, 5008, 5010, 5012, 5014, 5016 and 5018 can be trained with use of training data pertaining to one specific user, global predictive model 5020 can be trained with training data from detected clothing article wear events from a plurality of users, and in one embodiment, all registered users of system 100. Training data for training predictive model 5016 is shown in FIG. 5J. Global predictive model 5018 as shown in FIG. 5J can be trained with iterations of training data, and once trained can be configured to respond to query data. Training data for training global predictive model 5020 can include iterations of training data, clothing article wear event characterizing parameter values associated to a certain clothing article wear event stored in clothing article wear events area 2122 in combination with volunteered data of the owner user specified in the clothing article wear event. Iterations of training data for training global predictive model 5020 can include, in one embodiment, clothing article wear event parameter values characterizing the wear event. The volunteered data can include data volunteered by the user on registration and can be included within registration data sent by a user at send block 1301 in the flowchart of FIG. 2. The volunteered data can include user demographic data, e.g., specifying age, educational level, and/or geospatial coordinates of a residence of the user. In the described scenario involving iterations of training data, the volunteered data can define output data in a supervised machine learning training scenario, so that clothing article wear event characterizing parameter values can be trained on sets of volunteered data so that global predictive model 5020 by machine learning learns of a relationship between volunteered data, e.g., demographic data, and clothing article wear event characterizing parameter values. In such manner, after sufficient iterations of training data, global predictive model 5020 is able to predict a set of clothing article wear event characterizing parameter values based upon input query data that specifies a set of volunteered data, e.g., demographic data. Global predictive model 5020, once trained, is able to respond to query data. Query data, as depicted in FIG. 5J, can include a set of user volunteered data in association with article type. In response to application of the described query data, global predictive model 5020 can output a set of parameter values characterizing predicted article predicted to be acquired by a user. Thus, global predictive model 5020, in response to applied query data, can return predictions that specify attributes of a clothing article to be acquired by a user.

Importantly, because the query data specifies including only volunteered data, e.g., demographic data, global predictive model 5020 can return predictions for a certain new onboarding user who presented to manager system 110 volunteered data, e.g., demographic data, but who has not yet contributed any clothing article wear event data or who has not contributed substantial clothing article wear event data sufficient for return of confidence threshold satisfying predictions using user-specific predictive models trained using the wear event data. Manager system 110 can determine that a user is a new user based on the number of wear events detected for the user satisfying a low threshold. Global predictive model 5020 can return predictions for a new user based on the new user's volunteered data, e.g., demographic data, and, based on the clothing wearing behavior of other users of system 100 sharing attributes of volunteered data with the new onboarding user, can return predictions as to the new user's preferences.

Manager system 110 can be configured so that at profile generating block 1109, manager system 110 queries global predictive model 5020 for return of profile data for a certain user on the condition that manager system 110 ascertains that the certain user is a new onboarding user, and there is insufficient training data available for returning predictions as to behavior of the certain user within a threshold satisfying level of confidence with use of predictive model 5006, predictive model 5008, predictive model 5010, predictive model 5012, predictive model 5014, predictive model 5016, and predictive model 5018. There is set forth herein according to one embodiment a method wherein the method includes performing examining clothing article data stream data of a plurality of users for determination of clothing article wear events of the plurality of users, applying data of the wear events of the plurality of users as training data for training a global predictive model that is trained with demographic data of the plurality of users, and wherein the method includes (i) determining that a second user is a new user based on a number of wear events for the second user satisfying a low threshold, and (ii) responsively to the determining that the second user is a new user querying the global predive model for return of second user profile data for the second user and sending prompt data to the second user, wherein the prompt data prompts the second user to perform an action, and wherein the sending prompt data is performed in dependence on the second user profile data.

Various available tools, libraries, and/or services can be utilized for implementation of predictive models herein as set forth in connection with FIGS. 5A-5J. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service provided by IBM® WATSON® can provide access to libraries of APACHE® SPARK® and IBM® SPSS® (IBM® WATSON® and SPSS® are registered trademarks of International Business Machines Corporation and APACHE® and SPARK® are registered trademarks of the Apache Software Foundation. A machine learning service provided by IBM® WATSON® can provide access set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Machine learning predictive models herein, e.g., as set forth in connection with FIGS. 5A-5J, can incorporate carious machine learning technologies, e.g., neural networks, support vector machines (SVM), Bayesian networks, Random Forests, curve fitting, and/or other machine learning technologies.

On completion of training block 1108, manager system 110 can proceed to block 1109. At block 1109, manager system 110 can perform profile generating for generation of profile data characterizing at least one preference of one or more user. Manager system 110 performing profile generating at block 1109 can include manager system 110 querying predictive models 5006, 5008, 5010, 5012, 5014, 5016, and 5018.

Manager system 110 at profile generating block 1109 can query color combination predictive model 5006 with a palette of colors for return of an associated preferred combination of colors of a user associated to each query color. Color combination predictive model 5006 can return a confidence level associated to each predicted color combination.

Manager system 110 performing profile generating block 1109 can include manager system 110 querying longevity predictive model 5008 with the plurality of article types. Longevity predictive model 5008 can return in response to the queries a succession of predicted longevity parameter values associated to each article type, e.g., in terms of length of time since first use, and/or number of wears. Manager system 110 can aggregate, e.g., average, the results to provide a general longevity parameter value for the user across all article types. Manager system 110 can assign a confidence level to longevity prediction defined by the general longevity parameter value depending on the variability of the return predictions using longevity predictive model in dependence on article type. For example, if the return predictions are consistent across different article types, manager system 110 can assign a higher than baseline confidence level to the general longevity parameter value, whereas if the user exhibits a behavior of different longevity usages across different article types, manager system 110, using longevity predictive model 5008, can assign a lower than baseline confidence level.

In performing profile generating using pattern predictive model 5010, manager system 110 can query pattern predictive model 5008 using a variety of different article types, e.g., shirts, pants, socks, and can return predictions as to predicted pattern across the various article types. Pattern predictive model 5010, for each query, can return a ranked ordered list of preferred patterns across article types. Manager system 110 can aggregate, e.g., average, the results to provide a general pattern preference for the user across all article types. Manager system 110, in generating the user profile, can aggregate the returned data across the different article types used as query data, and manager system can assign a confidence level to the aggregated data in dependence on the variability amongst article types. Manager system 110 can assign higher than baseline confidence levels in the case that the ranked order list of preferred patterns is consistent among article types, and can assign lower than baseline confidence level to the returned ranked order list in the case that the user exhibits divergent pattern preferences amongst article types.

In profile generating using brand predictive model 5012, manager system 110 can query brand predictive model 5012 using different article types. For each article type, brand predictive model 5012 can return the ordered list of brands preferred by the user. Manager system 110 can aggregate, e.g., average, the results to provide a general brand preference for the user across all article types. Manager system 110 can assign a confidence level for the general brand preference ranked order list, in dependence on the variability of the returned data across different article types. Manager system 110 can assign a higher than baseline confidence level to the ranked order list of brand preference in the case that the user exhibits a behavior of consistency across article types, and can assign a lower than baseline confidence level to the ranked order list of preferred brands in the case that the user exhibits divergent behavior amongst article types. In other words, if the user exhibits consistent brand preference for brand ABC across all article types, e.g., including pants, shirts and socks, the confidence level assigned to the user's preference for brand ABC can be higher than in the case that the user exhibits the brand preference for ABC only for socks, and not shirts or pants.

Manager system 110, in performing user profile generating using style predictive model 5014, can query style predictive model 5014 using query data specifying a variety of article types, and for each article type, can return a ranked order list of styles for the article type. Manager system 110 can aggregate, e.g., average the returned ranked order list for return of an overall general style preference of the user, and can assign a confidence level to the general style preference of the user in dependence on the variability of the user's behavior across article types. Manager system 110 can assign a higher than baseline confidence level to the ranked order list of preferred styles in the case that the user exhibits consistent behavior across different article types, and can assign a lower than baseline confidence level to the ranked order list of preferred styles in the case that the user exhibits variable behavior across article types, e.g., only prefers the classical style for socks, but not for shirts or pants.

In profile generating using material predictive model 5016, manager system 110 can query material predictive model 5016 using different article types. For each article type, material predictive model 5016 can return the ordered list of materials preferred by the user, e.g., cotton, silk, wool, leather, polyester, rayon, etc. Manager system 110 can aggregate, e.g., average, the results to provide a general material preference for the user across all article types. Manager system 110 can assign a confidence level for the general material preference ranked order list in dependence on the variability of the returned data across different article types. Manager system 110 can assign a higher than baseline confidence level to the ranked order list of brand preference in the case that the user exhibits a behavior of consistency across article types, and can assign a lower than baseline confidence level to the ranked order list of preferred brands in the case that the user exhibits divergent behavior amongst article types. In other words, if the user exhibits consistent material preference for the material rayon across all article types, e.g., including pants, shirts and socks, the confidence level assigned to the user's preference for rayon can be higher than in the case that the user exhibits the material preference for rayon only for socks, and not shirts or pants.

In profile generating using color predictive model 5018, manager system 110 can query color predictive model 5018 using different article types. For each article type, material predictive model 5018 can return the ordered list of colors preferred by the user, e.g., red, green, blue, etc. Manager system 110 can aggregate, e.g., average, the results to provide a general color preference for the user across all article types. Manager system 110 can assign a confidence level for the general color preference ranked order list in dependence on the variability of the returned data across different article types. Manager system 110 can assign a higher than baseline confidence level to the ranked order list of color preferences in the case that the user exhibits a behavior of color preference consistency across article types, and can assign a lower than baseline confidence level to the ranked order list of preferred colors in the case that the user exhibits divergent color preference behavior amongst article types. In other words, if the user exhibits consistent color preference for the color across all article types, e.g., including pants, shirts and socks, the confidence level assigned to the user's preference for rayon can be higher than in the case that the user exhibits the color preference for blue only for socks, and not shirts or pants.

Manager system 110, in generating a user profile dataset at profile generating block 1109, can associate additional data to the user profile dataset in addition to the described user preference data determined by querying of predictive models 5006, 5008, 5010, 5012, 5014, 5016, and 5018. For example, manager system 110 at block 1109, in generating a profile dataset for a certain user, can associate to the profile dataset a current geospatial coordinate location of the user, as reported by manager system 110 at profile generating block 1109. In addition to associating a current geospatial coordinate location of a user, a user profile dataset defining a profile of a user can also associate recent purchase history data of the user, e.g., occurring within a threshold time window of a current time. The recent purchase history data of the user can include, e.g., purchase history data that specifies a color of an arbitrary product (e.g., clothing article or non-clothing article) of the user within a threshold time window.

Permissions data of registration data sent at block 1109 included within registration data sent by UE devices at block 1301 include permissions to utilize purchase history data as may be recorded within a product purchasing application running on a UE device of the user. Permissions data within registration data can alternatively, or in addition, include permissions to utilize banking account transaction data of a user as recorded on a user banking account or stored on a third-party banking enterprise entity system. With the recent purchase transaction data included within profile, there can be specified for recent purchases of a user various data items regarding purchases procured, including a color attribute of a recently purchased product.

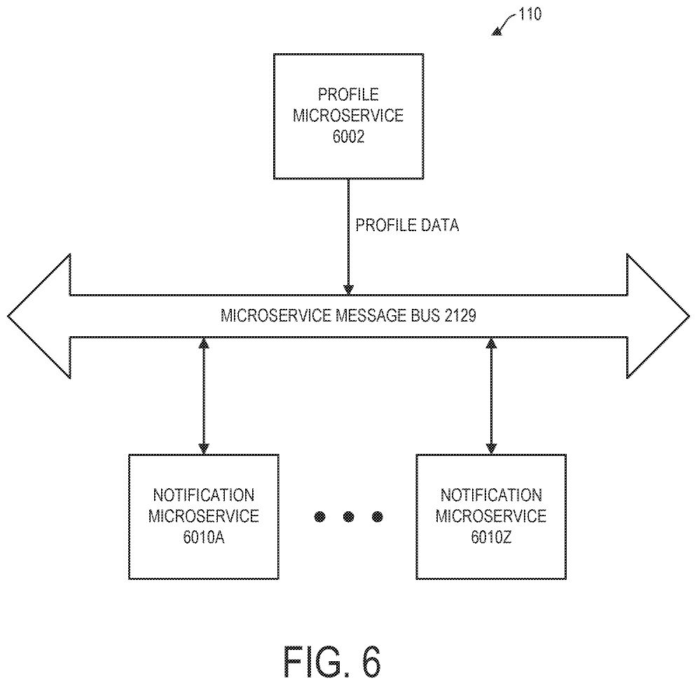

Manager system 110, on completion of profile generating block 1109, can proceed to store block 1110. At store block 1110, manager system 110 can store the generated user profile generated at block 1109 into users area 2121 of data repository 108. On completion of store block 1110, manager system 110 can proceed to action decision block 1111. At action decision block 1111, manager system 110 can return an action decision, which can specify that one or more notifications is to be sent to the user associated to the wear event detected at block 1106. Manager system 110 can be configured to perform an action decision by operation of logic encoded into the configuration of a microservices system of manager system 110 that features microservice message bus 2129. In one aspect, manager system 110 can be configured in accordance with the microservices architecture depicted in FIG. 6.

Referring to FIG. 6, FIG. 6 illustrates a microservices architecture that can be incorporated into manager system 110. Referring to the microservices architecture depicted in FIG. 6, manager system 110 running profile microservice 6002 can include manager system 110 running user profile process 117 to run profile microservice 6002 in order to output profile data to microservice message bus 2129. For example, manager system 110 running profile microservice 6002 can iteratively, when each profile is generated, output profile data defined by a data object according to one example set forth as follows: <userID=XX>, <profiletimestamp=XX>, <colorcombination1=XX, confidence=XX>, . . . <longevity=XX>, <pattern1=XX, confidence=XX>, <brand1=XX, confidence=XX>, . . . <style1=XX, confidence=XX>, . . . <material1=XX, confidence=XX>, <color1=XX, confidence=XX>, . . . <currentgeospatialcoordinates=XX>, <recentpurchasehistory=XX>.

The described microservices architecture can include various microservices 6010A-6010Z that can iteratively query message bus 2129. The various microservices 6010A-6010Z can iteratively query message data residing on the microservice message bus 2129 where the messages are defined by profile data sent by profile microservice 6002. On the determination that message data satisfies the triggering condition for a certain notification microservice, the certain notification microservice of microservices 6010A-6010Z can be activated to send an item acquisition notification defining prompting data to the user specified in the message data matching the triggering condition of the notification microservice. The prompting data can prompt a specified action on the part of a user, e.g., to acquire a specified item specified in a notification.

In another aspect of the microservices architecture depicted in FIG. 6, the depicted microservices architecture can include a plurality of notification microservices 6010A-6010Z. Notification microservices 6010A-6010Z can iteratively interrogate profile data messages that have been sent to microservice message bus 2129 by profile microservice 6002. Notification microservices 6010A-6010Z can have associated (a) triggering condition data, and (b) notification attribute data. Triggering condition data of a respective notification microservice can include one or more criterion that causes a notification to be triggered. The notification attribute data specifies one or more characteristic of the message that is transmitted. Notification data can define prompting data that prompts a user to take a specified action specified by a notification, e.g., acquire an item that is referenced in the notification.

Triggering conditions and notification attributes associated to various notification exemplary microservices are summarized in Table B.

TABLE B

| Microservice | Triggering condition data | Notification attribute data |
|---|---|---|
| 6010A | User has a reported profile data | Notification is sent to a user |
| | specifying a general product | specifying that an item is available |
| | longevity preference parameter | for acquisition by the user that has |
| | value satisfying a threshold | passed a durability test. The item |
| | with a threshold satisfying level of confidence. | can be a household furnishing item |
| | | e.g., a carpet, cookware, or another |
| | | household furnishing item. The |
| | | item can be a non-household |
| | | furnishing item such as an |
| | | automobile. |
| 6010B | User has acquired a first | Notification is sent to a user |
| | household furnishing item of a | specifying that a complementary |
| | first color within a threshold | item is available for acquisition by |
| | time window and has a | the user of the certain color that is |
| | preferred combined certain | complementary to the first |
| | color associated to the first | household furnishing item. The |
| | color according to a threshold | microservice can use a |
| | satisfying level of confidence. | complementary item lookup table |
| | | to determine a complementary |
| | | item (chairs with tables, dishes |
| | | with cups, etc.) |
| 6010C | User has a general brand | Notification is sent to a user |
| | preference for brand ABC | specifying that an item is available |
| | satisfying a high threshold with | for acquisition branded according |
| | a threshold satisfying level of | to brand ABC. The item can be a |
| | confidence. | household furnishing item e.g., a |
| | | carpet, cookware, or another |
| | | household furnishing item. The |
| | | item can be a non-household |
| | | furnishing item. |
| 6010D | User has a general material | Notification is sent to a user |
| | preference for material rayon | specifying that an item is available |
| | satisfying a high threshold with | for acquisition comprising rayon. |
| | a threshold satisfying level of | The item can be a household |
| | confidence. | furnishing item e.g., a carpet, |
| | | linens, or another household |
| | | furnishing item. The item can be a |
| | | non-household furnishing item. |
| 6010E | User has a general material | Notification is sent to a user |
| | preference for the color blue | specifying that an item is available |
| | satisfying a high threshold with | for acquisition having the color |
| | a threshold satisfying level of | blue. The item can be a household |
| | confidence. | furnishing item e.g., a carpet, |
| | | linens, cookware, bathware, or |
| | | another household furnishing item. |
| | | The item can be a non-household |
| | | furnishing item. |
| 6010F | User is a new user who is | The user is sent a notification |
| | predicted by query of predictive | notifying that a clothing article of |
| | model 5018 using user | type A having the parameter value |
| | demographic data to prefer with | B is available for acquisition. |
| | a threshold satisfying level of | |
| | confidence article type A | |
| | having parameter value B for a | |
| | second parameter (e.g., color or | |
| | another parameter), e.g., shirt of | |
| | the color red, or pants of the | |
| | material cotton, for example. | |

Regarding microservice 6010A, the triggering condition for microservice 6010A can be that profile data of the user specifies a product longevity with the general product longevity parameter value satisfying a threshold with a threshold satisfying level of confidence. The triggering condition can be, e.g., that the user has a general product longevity parameter value at or exceeding 0.7 with a level of confidence at or exceeding 0.6, for example. In response to the triggering condition being satisfied, manager system 110 running microservice 6010A can send a notification to a user. For sending the notifications in all the use cases summarized in Table B, manager system 110 can use the owner user identifier from the profile data sent to microservice message bus 2129 and can cross-reference that identifier with contact information including, e.g., messaging service such as email address information from data repository 108 in order to send the user notification. The notification attributes, in the case of microservice 6010A, can include a notification that specifies to the user that a household furnishing item is available for acquisition which has features of durability and long life.

The triggering condition for microservice 6010B can be that a user's profile indicates that the user has acquired a first household item of a first color within a threshold time window and has a preferred combined color associated to the first color according to a threshold satisfying level of confidence. The notification attributes associated to the triggering condition can include the notification attribute that a notification is sent specifying to the user associated to the first household item that it is available having the second color.

The triggering condition associated to microservice 6010C can be that the user has a general brand preference for brand ABC satisfying a high threshold with a threshold satisfying level of confidence. A notification associated to microservice 6010C can specify that a household furnishing item is available of brand ABC.

The triggering condition associated to microservice 6010D can be that the user has a general material preference for the material rayon satisfying a high threshold with a threshold satisfying level of confidence. A notification associated to microservice 6010D can specify that a household furnishing item is available for acquisition by the user that comprises rayon.

The triggering condition associated to microservice 6010E can be that the user has a general color preference for the color blue satisfying a high threshold with a threshold satisfying level of confidence. A notification associated to microservice 6010E can specify that a household furnishing item is available for acquisition by the user that comprises the color blue.

A triggering condition for microservice 6010F can be that the user is a new user who is predicted with use of global predictive model 5020 to prefer article type A having parameter value B. In one example, article type A can specify a shirt, and parameter value B can specify a shirt having the color red. The notification attributes associated to microservice 6010F can specify that the sent notification prompts the user to acquire an item having article type A and parameter value B, e.g., a shirt having the color red in the described example.

In other embodiments, additional microservices, e.g., microservices 6010G through 6010L can be configured according to microservices 6010A-6010H and can have triggering conditions according to triggering conditions for microservices 6010A-6010H, except that there is an additional geofence criterion so that the associated notification sent by the microservice is sent on the further criterion that a geofence condition is satisfied, e.g., specifying that user has breached specified geofence coordinated associated to an item acquisition venue, e.g. a certain retail store. In the example of microservices 6010A-6010F, the associated notification attribute data can specify that the item referenced in the notification is available at the certain retail store associated to the described geofence. In any of the described examples, the notification attributes regarding household furnishing attributes can be replaced by alternative notification attributes, e.g., specifying that instead of a household furnishing item, a clothing item is available for acquisition to the user, or a non-clothing and non-household furnishing item is available for acquisition.

In one embodiment, profile message data sent to microservice message bus 2129 can be tagged with a certain classification tag. Notification microservices 6010A-6010Z can subscribe to the certain classification tag so that they are enabled to examine profile data and responsively determine whether a notification has been triggered.

On completion of block 1111, manager system 110 can proceed to block 1112. At block 1112, manager system 110 can send a notification prompting a prescribed action, e.g., in accordance with notification of the described notification microservices 6010A-6010Z. On completion of send block 1112, manager system 110 can proceed to return block 1113. At return block 1113, manager system 110 can return to stage prior block 1101 to iterative received new registration data from new users or updated registration data from registered user and manager system 110 can iteratively perform the loop of blocks 1101-1113 for a deployment period of system 100. At return block 1204 computing environments 120A-120Z can return to a stage prior to block 1201 and can iteratively perform the loop of blocks 1201-1204 for a deployment period of system 100. At return block 1303 UE devices 130A-130Z can return to a stage prior to block 1301 and can iteratively perform the loop of blocks 1301-1304 for a deployment period of system 100.

Embodiments herein can provide offer generation based on usage pattern of users measured using big data and, in one embodiment, with use of IoT devices with image processing capabilities and machine learning techniques. A user may select and use some clothing articles more often than other clothing articles because they may fit well, or they could be comfortable to wear, and a person may believe they look better in some clothes than others, etc. Accordingly, embodiments herein recognize that a user may tend to wear select clothing articles more often than other clothing articles. Embodiments herein recognize that organizations do not have a mechanism to create a usage profile for an apparel item. Embodiments herein can create offers for item providers, e.g., retailers offering clothing article items or non-clothing article items based on a usage pattern of a user.

According to one embodiment, a consortium of retailers can create an apparel details database which has details of apparel sold in the past as well as current available stocks. Details includes types of clothes (formal, informal, clothes for function, winter/summer clothes), patterns (strips, checks, floral, plain), color, and size.

Home apparatus, e.g., clothes-laundering appliances such as washing machines, can be equipped with camera based IoT devices. A user can register contact address information, e.g., messaging service address information and/or mobile number for usage based on proximity promotional offers while also maintaining at the user's residence a clothes-laundering appliance with camera and image processing support capability.

When a user washes their clothes then a system having a camera IoT device enabled with image processing support capabilities can attempt to provide the following details about the clothes being washed: Type of clothing article used (shorts, shirt, frock, etc.), color, material, size, brand,

If an image processing system is unable to ascertain details from images of clothing articles as they are being washed, then a predictive model can be queried for return of additional parameter values.

Image recognition processing herein can include use of a publicly accessible image database such as the ImageNet™ database. An image database can include labeled images for training, e.g., of convolutional neural networks using a graphics processing unit (GPU) accelerated deep learning framework such as Caffe2™, Chainer™, Microsoft Cognitive Toolkit™, MXNet™, PaddlePaddle™ Pytorch™, TensorFlow™, and inference optimizers such as TensorRT™. The described machine learning image recognition framework can be incorporated into article predictive model 5002 and can be used for processing images sent by a residential IoT device 125A-125Z in some use cases conditionally on the condition that processing of data stream data from a camera based IoT device is not able to identify details about clothing articles being subject to laundering or being worn.

Extracted details can be analyzed to build a user profile. A user profile can be associated to the user through a messaging service address, e.g., email address or phone number. The user profile can be iteratively and continually updated to reflect the learned user's preferences. This data can be utilized, e.g., by article providers such as retailers who cater promotional material to the user based on profile. Information on successful item acquisition prompting promotional campaigns can be sent back to system for use in reinforcement machine learning to enable more successful future campaigns.

In one example, a user can be provisioned with a clothes-laundering appliance that includes a camera based IoT device for support of image processing capability and they user can send registration data to register the user to receive from manager system 110 promotional offers based on usage. As clothing items are, e.g., washed in a washing machine, a camera based IoT device capable of supporting image processing capabilities can enable manager system 110 to determine clothing article parameter value details about, e.g., clothing article type, brand, size, pattern, etc.

This data can be sent to clothing article predictive model 5002 which can be trained with training data that comprises, e.g., a large collection of images of apparel sold by various clothing brands, retailers. Machine learning systems such as predictive model 5002 can help identify details about a clothing article. Over a deployment period, user profiles can be created which include data items such as: {most/moderate/list used clothes: frequency of use: type of clothes: list of brands: segmentation—brands/cost}. Article providers such as retailers can use this information for promotional offers and manager system 110 can push promotional offers when a user is in proximity specific retail store and the user has been using clothing articles having certain characteristics.

Embodiments herein recognize that clothing article usage patterns can provide inputs for return of behavioral preference profile data, e.g., specifying, e.g., style of clothes (formal, informal, clothes for events/functions), specific pattern (check, strips, floral or other designs) favorable to user, brand details, segmentation, color preferences, material preference, color combination preference and the like. This data can enable more effective item acquisition that is more accurately aligned to a user's actual preferences.

An image processing deep machine learning system can be provided to help classification and identify parameter values of detected clothing articles. In one embodiment, a convolution neural network for graphic processing unit (GPU) accelerated deep learning framework can be provided to process data stream data from a camera based IoT device with use of an apparel database of various article providers to identify clothing article parameter values, e.g., materials, colors, and patterns (checks, stripes, floral, etc. brands, size).

In one embodiment, system 100 can utilize data stream data from an additional IoT based camera device, e.g., disposed at an ingress/egress doorway. Such an IoT based camera device can output image data representing clothing articles the user wears most often when they leave the house, as well as the combinations of clothes (combination of pants, shirts, jackets, etc.). The combination of clothing article type (e.g., shirt worn with pants) will inform the profile of the user. In addition, the inclusion of a doorway disposed IoT device can enable the system to learn whether the user values certain brand combinations.

Embodiments herein can employ image processing and machine learning capabilities to identify clothing items used by users and create usage profile and targeted offers. Individualized user predictive models can be generated using statistical analysis of usage transaction data for the user, thereby enabling generating profile data specific to the user. Embodiments herein can use image processing and machine learning capabilities to identify clothing articles used by users to generate user specific profile data and user specific prompting data.

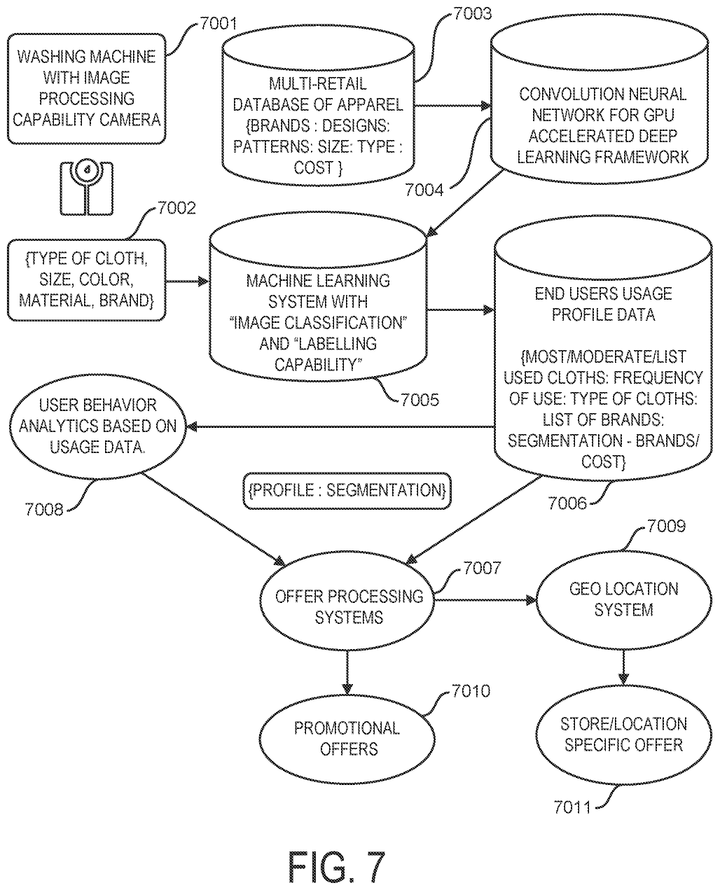

In reference to the flowchart of FIG. 7, there are depicted stages 7001-7011 illustrating a specific method for performance by manager system 110 interoperating with a computing environment of computing environments 120A-120Z according to one embodiment.

Certain embodiments herein may offer technical computing advantages and practical applications involving computing advantages to address problems arising in the realm of computer networks and computer systems. Embodiments herein can include IoT devices disposed in a computing environment collocated with the user's residence, in one example. The IoT devices can output sensor data indicating usage of clothing articles by user. Data stream data output by the IoT devices can be received and processed for return of parameter values. Embodiments herein can include discovering missing parameters with use of predictive models that are trained by machine learning training processes. Embodiments herein can generate and record clothing article wear events by a user. In response to detection of a clothing article wear event, clothing article wear event data can be stored in a data repository, and the clothing article wear event can be used to train a plurality of predictive models. A plurality of predictive models can be trained with machine learning processes and then the plurality of predictive models can be queried for return of user profile data. Embodiments herein can include reporting of user profile data to a microservice message bus. Various notification microservices can iteratively interrogate the microservice message bus for examination of message data published to the message bus and identification of user profile data defined by the message data matching a triggering condition specified by the respective notification microservices. On the identification of user profile data matching a notification triggering condition, a notification function of a notification microservice can be activated to send a notification to a user. Various decision data structures can be used to drive artificial intelligence (AI) decision making. Decision data structures as set forth herein can be updated by machine learning so that accuracy and reliability is iteratively improved over time without resource consuming rules intensive processing. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

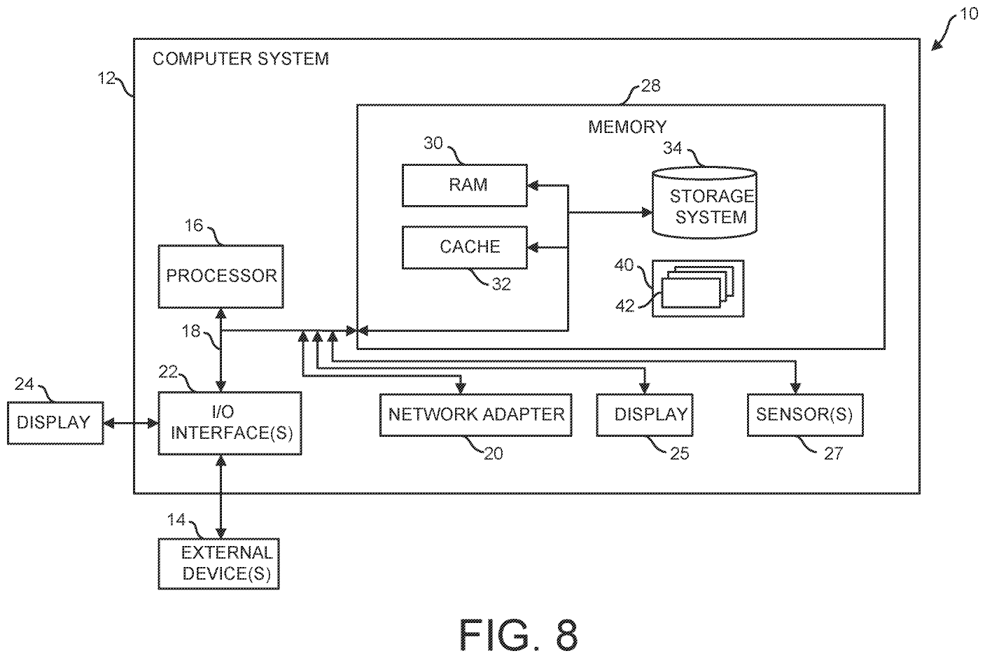

FIGS. 8-10 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 8, a schematic of an example of a computing node is shown. Computing node 10 is only one example of a computing node suitable for use as a cloud computing node and is not intended to suggest any limitation as to the scope of use or functionality of embodiments of the invention described herein. Regardless, computing node 10 is capable of being implemented and/or performing any of the functionality set forth hereinabove. Computing node 10 can be implemented as a cloud computing node in a cloud computing environment, or can be implemented as a computing node in a computing environment other than a cloud computing environment.

In computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

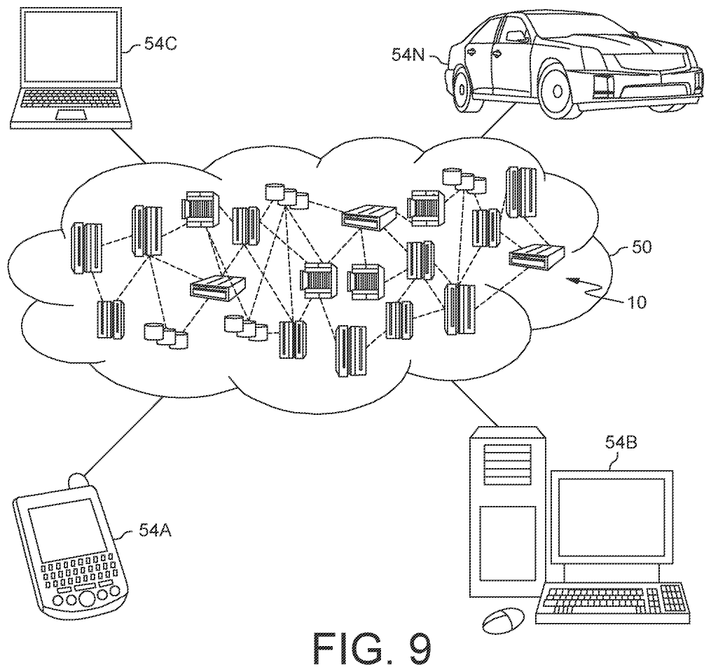

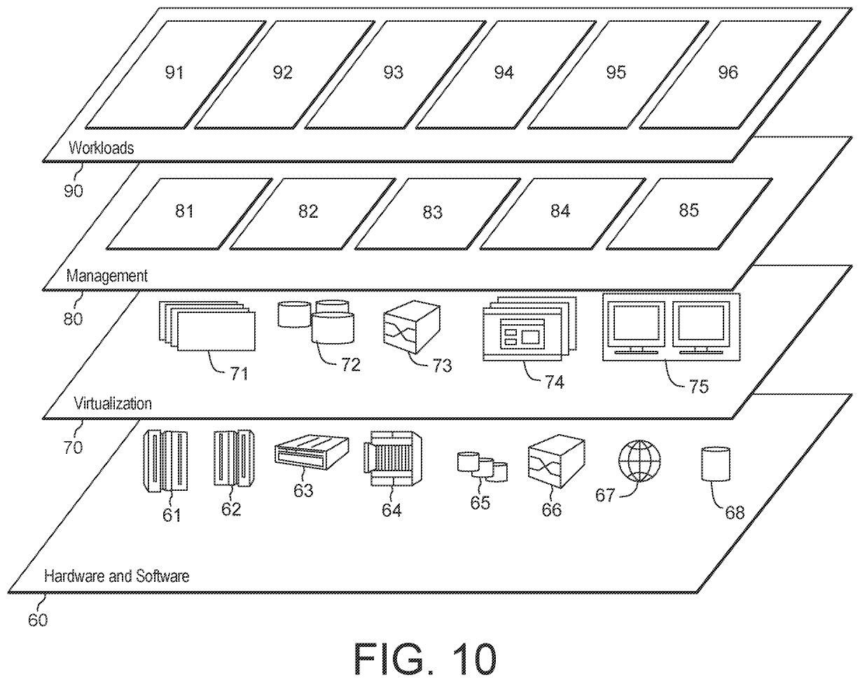

As shown in FIG. 8, computer system 12 in computing node 10 is shown in the form of a computing device. The components of computer system 12 may include, but are not limited to, one or more processor 16, a system memory 28, and a bus 18 that couples various system components including system memory 28 to processor 16. In one embodiment, computing node 10 is a computing node of a non-cloud computing environment. In one embodiment, computing node 10 is a computing node of a cloud computing environment as set forth herein in connection with FIGS. 9-10.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. One or more program 40 including program processes 42 can generally carry out the functions set forth herein. In one embodiment, manager system 110 can include one or more computing node 10 and can include one or more program 40 for performing functions described with reference to manager system 110 as set forth in the flowchart of FIG. 2 and the flowchart of FIG. 7, and the functions described with reference to microservices architecture diagram of FIG. 6. In one embodiment, computing environments 120A-120Z can include one or more computing node 10 and can include one or more program 40 for performing functions described with reference to computing environments 120A-120Z as set forth in the flowchart of FIG. 2 and the flowchart of FIG. 7. In one embodiment, one or more UE device 130A-130Z can include one or more computing node 10 and can include one or more program 40 for performing functions described with reference to one or more UE device 130A-130Z as set forth in the flowchart of FIG. 2. In one embodiment, the computing node based systems and devices depicted in FIG. 1 can include one or more program for performing function described with reference to such computing node based systems and devices.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc. In addition to or in place of having external devices 14 and display 24, which can be configured to provide user interface functionality, computing node 10 in one embodiment can include display 25 connected to bus 18. In one embodiment, display 25 can be configured as a touch screen display and can be configured to provide user interface functionality, e.g., can facilitate virtual keyboard functionality and input of total data. Computer system 12 in one embodiment can also include one or more sensor device 27 connected to bus 18. One or more sensor device 27 can alternatively be connected through I/O interface(s) 22. One or more sensor device 27 can include a Global Positioning Sensor (GPS) device in one embodiment and can be configured to provide a location of computing node 10. In one embodiment, one or more sensor device 27 can alternatively or in addition include, e.g., one or more of a camera, a gyroscope, a temperature sensor, a humidity sensor, a pulse sensor, a blood pressure (bp) sensor or an audio input device. Computer system 12 can include one or more network adapter 20. In FIG. 9 computing node 10 is described as being implemented in a cloud computing environment and accordingly is referred to as a cloud computing node in the context of FIG. 9.

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components 96 for predicting user behavior as set forth herein. The processing components 96 can be implemented with use of one or more program 40 described in FIG. 8.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
obtaining clothing article data stream data from one or more internet of things (IoT) device disposed in a computing environment, wherein the computing environment is collocated with a residence of a user, the clothing article data stream data representing one or more clothing article of the user;
examining data of the clothing article data stream data to determine at least one clothing article parameter value of the one or more clothing article;
in dependence at least one clothing article parameter value of the one or more clothing article, providing user profile data that specifies predicted behavior of the user; and
sending prompting data to the user, wherein the prompting data prompts the user to perform an action, and wherein the sending prompting data is performed in dependence on the user profile data.

2. The computer implemented method of claim 1, wherein the data stream data representing one or more clothing article of the user includes a representation of the one or more clothing article captured while the one or more clothing article is disposed in a clothes-laundering appliance.

3. The computer implemented method of claim 1, wherein data stream data representing one or more clothing article of the user includes a representation of the one or more clothing article captured with the one or more clothing article being worn by the user while the user is exiting the residence of the user.

4. The computer implemented method of claim 1, wherein the data stream data representing one or more clothing article of the user includes a representation of the one or more clothing article captured while the one or more clothing article is disposed in a clothes laundering appliance, and wherein data stream data representing one or more clothing article of the user includes a representation of the one or more clothing article captured with the one or more clothing article being worn by the user while the user is exiting the residence of the user.

5. The computer implemented method of claim 1, wherein examining data of the clothing article data stream data includes performing image recognition using the data stream data to extract clothing article parameter values, and applying one or more extracted parameter value of the clothing article parameter values as query data to a predictive model for return of additional clothing article parameter values, wherein the predictive model has been trained by machine learning.

6. The computer implemented method of claim 1, wherein the method includes determining from the examining a plurality of clothing article parameter values, training first and second predictive models for predicting behavior of the user, the training first and second predictive models including using parameter values the plurality of clothing article parameter values, querying the first and second predictive models for return of profile data characterizing predicted behavior of the user, and wherein the action prompted by the prompting data is determined in dependence on the profile data characterizing predicted behavior of the user.

7. The computer implemented method of claim 1, wherein the action prompted for by the prompting data prompts the user to acquire a non-clothing item.

8. The computer implemented method of claim 1, wherein the action prompted for by the prompting data prompts the user to acquire a non-clothing item provided by a household furnishing item.

9. The computer implemented method of claim 1, wherein the profile data includes data specifying a predicted color preference of the user and wherein the action prompted for by the prompting data prompts the user to acquire a non-clothing item according to the predicted color preference of the user.

10. The computer implemented method of claim 1, wherein the profile data includes data specifying a predicted brand preference of the user and wherein the action prompted for by the prompting data prompts the user to acquire a non-clothing item according to the predicted brand preference of the user.

11. The computer implemented method of claim 1, wherein the profile data includes data specifying a predicted material preference of the user and wherein the action prompted for by the prompting data prompts the user to acquire a non-clothing item according to the predicted material preference of the user.

12. The computer implemented method of claim 1, wherein the profile data includes data specifying a predicted color combination preference of the user and wherein the action prompted for by the prompting data prompts the user to acquire a non-clothing item according to the predicted color combination preference of the user.

13. The computer implemented method of claim 1, wherein the method includes publishing the profile data to a microservice message bus, and wherein the method includes examining the profile data by a plurality of notification microservices to determine whether a triggering condition for sending a notification specifying the action has been satisfied.

14. The computer implemented method of claim 1, wherein the method includes performing examining clothing article data stream data of a plurality of users for determination of clothing article wear events of the plurality of users.

15. The computer implemented method of claim 1, wherein the method includes performing examining clothing article data stream data of a plurality of users for determination of clothing article wear events of the plurality of users, applying data of the wear events of the plurality of users as training data for training a predictive model that is trained with demographic data of the plurality of users, and wherein the method includes (i) determining that a second user is a new user based on a number of wear events for the second user satisfying a low threshold, and (ii) responsively to the determining that the second user is a new user querying the predictive model for return of second user profile data for the second user and sending prompt data to the second user, wherein the prompt data prompts the second user to perform an action, and wherein the sending prompt data is performed in dependence on the second user profile data.

16. A computer program product comprising:
a computer readable storage medium readable by one or more processing circuit and storing instructions for execution by one or more processor for performing a method comprising:
obtaining clothing article data stream data from one or more internet of things (IoT) device disposed in a computing environment, wherein the computing environment is collocated with a residence of a user, the clothing article data stream data representing one or more clothing article of the user;
examining data of the clothing article data stream data to determine at least one clothing article parameter value of the one or more clothing article;
in dependence at least one clothing article parameter value of the one or more clothing article, providing user profile data that specifies predicted behavior of the user; and
sending prompting data to the user, wherein the prompting data prompts the user to perform an action, and wherein the sending prompting data is performed in dependence on the user profile data.

17. The computer program product of claim 16, wherein the data stream data representing one or more clothing article of the user includes a representation of the one or more clothing article captured while the one or more clothing article is disposed in a clothes-laundering appliance.

18. The computer program product of claim 16, wherein data stream data representing one or more clothing article of the user includes a representation of the one or more clothing article captured with the one or more clothing article being worn by the user while the user is exiting the residence of the user.

19. The computer program product of claim 16, wherein the data stream data representing one or more clothing article of the user includes a representation of the one or more clothing article captured while the one or more clothing article is disposed in a clothes laundering appliance, and wherein data stream data representing one or more clothing article of the user includes a representation of the one or more clothing article captured with the one or more clothing article being worn by the user while the user is exiting the residence of the user.

20. A system comprising:
a memory;
at least one processor in communication with the memory; and
program instructions executable by one or more processor via the memory to perform a method comprising:
obtaining clothing article data stream data from one or more internet of things (IoT) device disposed in a computing environment, wherein the computing environment is collocated with a residence of a user, the clothing article data stream data representing one or more clothing article of the user;
examining data of the clothing article data stream data to determine at least one clothing article parameter value of the one or more clothing article;
in dependence at least one clothing article parameter value of the one or more clothing article, providing user profile data that specifies predicted behavior of the user; and
sending prompting data to the user, wherein the prompting data prompts the user to perform an action, and wherein the sending prompting data is performed in dependence on the user profile data.
